(19) United States
(12) Patent Application Publication
(10) Pub. No.: US 2025/0249932 A1
(43) Pub. Date: Aug. 7, 2025

(54) SYSTEM AND METHOD FOR AUTONOMOUS VEHICLE NAVIGATION IN MIXED-AUTONOMY TRAFFIC ENVIRONMENTS

(71) Applicants: University of Central Florida Research Foundation, Inc., Orlando, FL (US); The Regents of the University of California, Oakland, CA (US)

(72) Inventors: Yaser Pourmohammadi Fallah, Orlando, FL (US); Behrad Toghi, Orlando, FL (US); Rodolfo Valiente Romero, Orlando, FL (US); Ramtin Pedarsani, Oakland, CA (US)

(21) Appl. No.: 18/965,405

(22) Filed: Dec. 2, 2024

Related U.S. Application Data
(60) Provisional application No. 63/549,136, filed on Feb. 2, 2024.

(51) Int. Cl. B60W 60/00; B60W 50/00; G06N 3/092

(52) U.S. Cl. CPC B60W 60/0015; B60W 50/0097; G06N 3/092

(57) ABSTRACT

Described herein relates to a system and method for autonomous vehicle navigation. The technique may combine a Hybrid Predictive Network (HPN) and a Value Function Network (VFN), along with a safety prioritizer, to enhance decision-making and safety. The HPN, built on a symmetric encoder-decoder architecture, may utilize a series of observations to predict future scenarios. The VFN may also estimate state-action value functions, combining HPN's predictive capabilities with decision-making, improving navigation. A multi-step prediction chain may also use the HPN to generate future hypotheses based on observation history. The safety prioritizer, integrated within the VFN, may be configured to penalize high-risk actions, masking them when selected, increasing safety. Additionally, the system may apply deep reinforcement learning for high-level policy creation for safe tactical decision-making. The method may optimize social utility and/or may increase sample efficiency and safety, making significant strides in autonomous vehicle operation.

### CROSS-REFERENCE TO RELATED APPLICATIONS

This nonprovisional patent application claims priority to and the benefit of U.S. Provisional Patent Application No. 63/549,136 entitled “IMPLEMENTING SOCIAL COORDINATION AND ALTRUISM IN AUTONOMOUS DRIVING VEHICLES” filed Feb. 2, 2024 by the same inventors, all of which is incorporated herein by reference, in its entirety, for all purposes.

### FEDERALLY SPONSORED RESEARCH OR DEVELOPMENT

This invention was made with Government support under Grant No. CNS-1932037 awarded by National Science Foundation. The government has certain rights in the invention.

### BACKGROUND OF THE INVENTION

### 1. Field of the Invention

This invention relates, generally, to autonomous vehicles (hereinafter “AVs”). More specifically, it relates to a system and method for automatically training altruistic maneuver vehicle navigation for cooperative autonomous vehicles that sympathize with human drivers in human driven vehicles (hereinafter “HVs”).

### 2. Brief Description of the Prior Art

With the adoption of autonomous vehicles on the roads, a mixed-autonomy environment may be witnessed where autonomous and human-driven vehicles must learn to co-exist by sharing the same road infrastructure. To attain socially-desirable behaviors, autonomous vehicles must be instructed to consider the utility of other vehicles around them in their decision-making process.

Despite the advances in the autonomous driving domain, autonomous vehicles (hereinafter “AVs”) are still inefficient and limited in terms of cooperating with each other or coordinating with vehicles operated by humans. A group of autonomous vehicles and human-driven vehicles (hereinafter “HVs”) which work together to optimize an altruistic social utility—as opposed to the egoistic individual utility—can co-exist seamlessly and assure safety and efficiency on the road. Achieving this mission without explicit coordination among agents is challenging, mainly due to the difficulty of predicting the behavior of humans with heterogeneous preferences in mixed-autonomy environments.

Therefore, widespread adoption of autonomous vehicles will not become a reality until solutions are developed that enable these intelligent agents to co-exist with humans. This includes safely and efficiently interacting with human-driven vehicles, especially in both conflictive and competitive scenarios.

AVs can leverage their superior computation power, precision, and reaction time to avoid errors occurred by human drivers and drive more efficiently. Connecting AVs and HVs via vehicle-to-vehicle (hereinafter “V2V”) communication creates an opportunity for extended situational awareness and enhanced decision-making. The problem of concern is the cooperative decision-making in mixed-autonomy environments where AVs need to share the road infrastructure with human drivers. In such environments, a given AV interacts with other vehicles, whether autonomous or human-driven, and most likely faces conflictive and competitive scenarios where its individual interest does not necessarily align with that of other vehicles.

The next generation of roadway transportation systems will be safer and more efficient with connected autonomous vehicles. V2V communication enables AVs to constitute a form of mass intelligence and overcome the limitations of a single-agent planning in a decentralized fashion. If all vehicles on the road were connected and autonomous, V2V could allow them to coordinate and handle complex driving scenarios that require selflessness, e.g., merging to and exiting a highway and crossing intersections for example. However, a road shared by AVs and HVs naturally becomes a competitive scene due to their different levels of maneuverability and reaction time. In contrast with the full-autonomy case, here the coordination between HVs and AVs is not as straightforward since AVs do not have an explicit means of harmonizing with humans and therefor are required to locally account for the other HVs and AVs in their proximity.

Connected and automated vehicles (hereinafter “CAVs”) pursue a mission to enhance driving safety and reliability by bringing automation and intelligence into vehicles, which lessens the inherent human limitations such as range of vision, reaction time, and distraction. Adding the communication component to intelligent vehicles further improves their ability in perceiving the surrounding and creates an opportunity for mass coordination and cooperative decision-making. This inter-agent coordination is particularly important as the full potential of CAVs does not lie in operating a single vehicle on an empty road but rather from their seamless co-existence with other autonomous (AVs) and human-driven vehicles (HVs). Hence, the inherent problem of affecting the decision-making problem in the presence of multiple autonomous agents and human drivers, i.e. a mixed-autonomy multi-agent environment.

Accordingly, what is needed is a system and method that takes an end-to-end approach and allows the autonomous agents to implicitly learn the decision-making process of human drivers only from experience. A multi-agent variant of the synchronous Advantage Actor-Critic (hereinafter “A2C”) algorithm trains agents that coordinate with each other and can affect the behavior of human drivers to improve traffic flow and safety. Such a system and method should model an AV's maneuver planning in mixed-autonomy traffic as a partially-observable stochastic game and attempt to derive optimal policies that lead to socially-desirable outcomes using a multi-agent reinforcement learning framework. A quantitative representation of the AVs' social preferences includes in its design a distributed reward structure that induces altruism into their decision-making process. Such altruistic AVs can form alliances, guide the traffic, and affect the behavior of the HVs to handle competitive driving scenarios. Using a decentralized reward structure can induce altruism in the AVs behavior and incentivize them to account for the interest of other autonomous and human-driven vehicles despite the ambiguity of a human driver's willingness to cooperate with an autonomous vehicle. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to a method for automatic autonomous vehicle navigation. In an embodiment, the method may comprise the following steps: (a) importing, via a plurality of vehicle navigation sensors communicatively coupled to a processor, a plurality of observations of a mixed-autonomy environment at a predetermined time t into a Hybrid Predictive Network (HPN); (b) synthesizing, via the HPN, a plurality of future hypotheses of the mixed-autonomy environment during at least one alternative time, t+1, based on the imported observations; (c) estimating, via a Value Function Network (VFN) communicatively coupled to the HPN, state-action value functions based on the plurality of synthesized future hypothesis; and (d) penalizing, via a safety prioritizer of the VFN, at least one estimated high-risk state-action, and masking the at least one estimated high-risk state-action when the at least one high-risk state-action is selected.

In some embodiments, the step of synthesizing a plurality of future hypotheses further comprises the step of, generating, via the HPN, a multi-step prediction chain to transmit at least one of the plurality of future hypotheses to the VFN. In this manner, the method may further comprise the step of, generating, via a deep Reinforcement Learning (RL) module communicatively coupled to the VFN, a high-level policy for safe tactical decision-making with the input comprising a stack of the plurality of observations and a stack of the plurality of future hypotheses. In these other embodiments, the step of generating a high-level policy for safe tactile decision-making may further comprise the step of, training, via the deep RL module, a plurality of agents of the VFN, such that the estimated state-action value functions may optimize a Q-value that maximizes a social reward function. As such, the plurality of agents of the VFN may be trained in a semi-sequential manner.

In addition, in some embodiments, the HPN may employ a symmetric encoder-decoder architecture. In these other embodiments, the encoder may comprise at least three (3) convolutional layers and at least one fully connected layer. In this manner, the step of synthesizing, via the HPN, a plurality of future hypotheses of the mixed-autonomy environment may further comprise the step of, encoding, via the encoder, each of the plurality of observations to generate a plurality of hidden units. Additionally, in these other embodiments, the decoder may comprise at least three (3) convolution layers with at least one fully connected layer. As such, the step of synthesizing, via the HPN, a plurality of future hypotheses of the mixed-autonomy environment may further comprise the step of, subsequent to encoding each of the plurality of observations, decoding, via the decoder, each of the plurality of generated hidden units to product at least one future hypothesis for at least one portion of the mixed-autonomy environment.

In some embodiments, the method may further comprise the step of, extracting, via the encoder, spatial information from the plurality of observations, such that the spatial information may be transmitted to the deep RL module, optimizing training of the encoder-decoder architecture

Moreover, another aspect of the present disclosure pertains to a system for automatic autonomous vehicle navigation. In an embodiment, the system may comprise the following: (a) a computing device having a processor; and (b) a non-transitory computer-readable medium operably coupled to the processor, the computer-readable medium having computer-readable instructions stored thereon that, when executed by the processor, cause the system to automatically navigate an autonomous vehicle within a mixed-autonomy environment by executing instructions comprising: (i) importing, via a plurality of vehicle navigation sensors communicatively coupled to the processor, a plurality of observations of a mixed-autonomy environment at a predetermined time t into a Hybrid Predictive Network (HPN); (ii) synthesizing, via the HPN, a plurality of future hypotheses of the mixed-autonomy environment during at least one alternative time, t+1, based on the imported observations; (iii) estimating, via a Value Function Network (VFN) communicatively coupled to the HPN, state-action value functions based on the plurality of synthesized future hypothesis; and (iv) penalizing, via a safety prioritizer of the VFN, at least one estimated high-risk state-action and/or masking the at least one estimated high-risk state-action when the at least one high-risk state-action is selected.

In some embodiments, the step of synthesizing a plurality of future hypotheses of the executed instructions may further comprise the step of, generating, via the HPN, a multi-step prediction chain to transmit at least one of the plurality of future hypotheses to the VFN.

Additionally, in some embodiments, the executed instructions may further comprise the step of, generating, via a deep Reinforcement Learning (RL) module communicatively coupled to the VFN, a high-level policy for safe tactical decision-making with the input comprising a stack of the plurality of observations and a stack of the plurality of future hypotheses. In these other embodiments, the step of generating a high-level policy for safe tactile decision-making of the executed instructions may further comprise the step of, training, via the deep RL module, a plurality of agents of the VFN, such that the estimated state-action value functions may optimize a Q-value that maximizes a social reward function. In this manner, the plurality of agents of the VFN may be trained in a semi-sequential manner.

In some embodiments, the HPN may employ a symmetric encoder-decoder architecture. As such, the encoder may comprise at least three (3) convolutional layers and/or at least one fully connected layer. Accordingly, in these other embodiments, the step of synthesizing, via the HPN, a plurality of future hypotheses of the environment of the executed instructions may further comprise the step of, encoding, via the encoder, each of the plurality of observations to generate a plurality of hidden units. Additionally, in these other embodiments, the decoder may comprise at least three (3) convolution layers with at least one fully connected layer.

Furthermore, in some embodiments, the system may combine a Hybrid Predictive Network (HPN) and a Value Function Network (VFN), along with a safety prioritizer, to enhance decision-making and safety. The HPN, built on a symmetric encoder-decoder architecture, may utilize a plurality of observations to predict a plurality of future and/or potential scenarios. The VFN may be configured to estimate state-action value functions, combining HPN's predictive capabilities with decision-making, improving navigation. In addition, in these other embodiments, a multi-step prediction chain of the HPN may be configured to generate future hypotheses based on observation history. Moreover, the safety prioritizer, integrated within the VFN, may penalize high-risk actions, masking them when selected, increasing safety. The system may also apply deep reinforcement learning for high-level policy creation for safe tactical decision-making. The method may optimize social utility and/or may increase sample efficiency and/or safety, making significant strides in autonomous vehicle operation.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1A is a diagram illustrating a merging of an egoistic autonomous vehicle which disregards other vehicles in the vicinity, according to an embodiment of the present disclosure.

FIG. 1B is a diagram illustrating how cooperative autonomous vehicles can effectuate a safe merging condition, according to an embodiment of the present disclosure.

FIG. 2 is a multi-channel velocity map state representation which embeds the speed of a vehicle in pixel values for use in further controlling autonomous vehicles, according to an embodiment of the present disclosure.

FIG. 3 is a representation of a deep Q-network with 3D convolutional architecture for use in further controlling autonomous vehicle, according to an embodiment of the present disclosure.

FIG. 4 is an illustration of a multi-agent training and policy dissemination process, according to an embodiment of the present disclosure.

FIG. 5 is a chart and table illustrating a comparison between egoistic, cooperative-only, and sympathetic cooperative autonomous agents and how they interact with an autonomous or human-driven mission vehicle, a set of sampled mission vehicle's trajectories are illustrated on the left-side, relating to each of the 6 experiment setups, according to an embodiment of the present disclosure.

FIG. 6 illustrates a set of sample trajectories of the merging vehicle showing mostly successful merging attempts in HV+SC, compared to the failed attempts in HV+E, according to an embodiment of the present disclosure.

FIG. 7 is a chart showing a set of snapshots extracted from two scenarios with strongly sympathetic and weakly sympathetic agents, according to an embodiment of the present disclosure.

FIG. 8 is a graph showing that tuning SVO for autonomous agents reveals that an optimal point between caring about others and being selfish exists that eventually benefits all the vehicles in the group, according to an embodiment of the present disclosure.

FIG. 9 is a chart illustrating training performance of the three benchmark network architectures, according to an embodiment of the present disclosure.

FIG. 10 is a diagram illustrating a prediction-aware and/or social-aware cooperative driving approach for Multi-agent Cooperating Reinforcement Learning to improve autonomous vehicle safety, according to an embodiment of the present disclosure.

FIG. 11 is a diagram illustrating an architecture of a Hybrid predictive Network for one prediction step, according to an embodiment of the present disclosure.

FIG. 12 is a diagram illustrating a multi-step prediction chain and Safe Value Function Network (VFN), according to an embodiment of the present disclosure.

FIG. 13 is a graph showing a kinematic prediction baseline comparison in terms of positive error (PE) in meters, according to an embodiment of the present disclosure.

FIG. 14 is a plot showing a training and validation loss of the predictive network using and not using observation history, according to an embodiment of the present disclosure.

FIG. 15 is a set of images illustrating an internal representation of a plurality of features at different layers for a merging scenario, according to an embodiment of the present disclosure.

FIG. 16 is a set of images illustrating a prediction chain for merging when using and not using observation history, according to an embodiment of the present disclosure.

FIG. 17 is a set of graphs showing a performing enhancement in a highway merging scenario resulting from using prediction, in which safety is measured in terms of crash percentage and efficiency by average traveled distance, according to an embodiment of the present disclosure.

FIG. 18 is a set of images illustrating qualitative results of the prediction chain output for multiple scenarios, according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

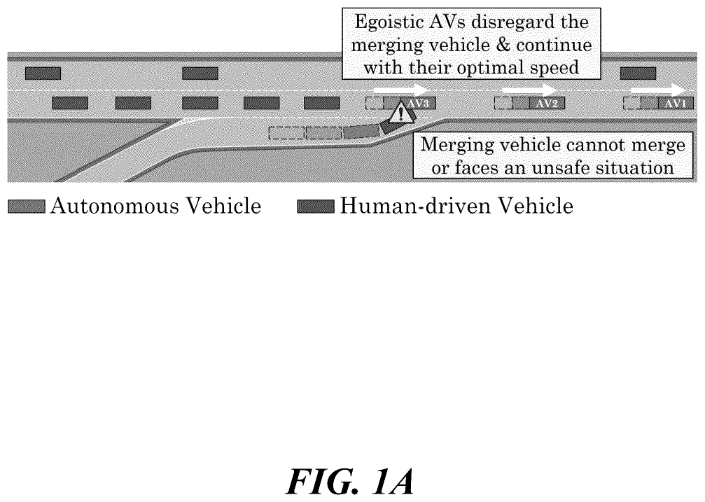

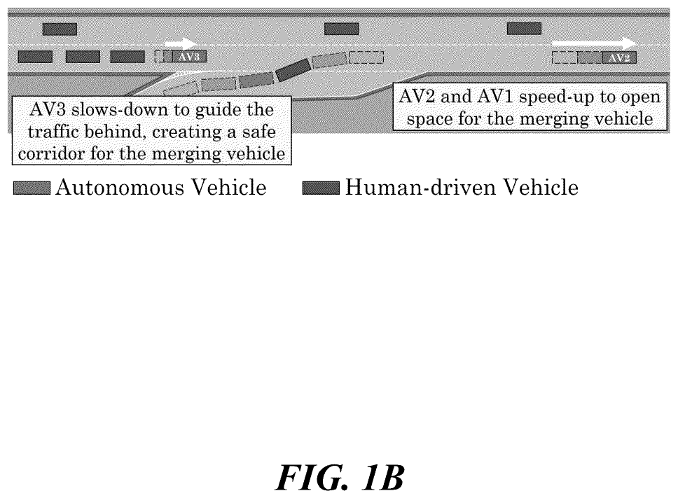

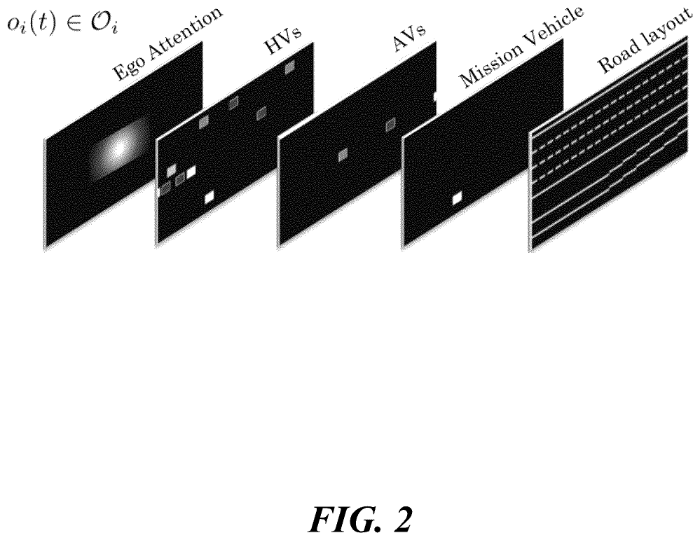

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. The techniques introduced here can be embodied as special-purpose hardware (e.g. circuitry), as programmable circuitry appropriately programmed with software and/or firmware, or as a combination of special-purpose and programmable circuitry.

Hence, embodiments may include a computing device-readable medium having stored thereon instructions which may be used to program a computing device (or other electronic devices) to perform a process. The computing device readable medium described in the claims below may be a computing device readable signal medium or a computing device readable storage medium. A computing device readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computing device readable storage medium would include the following: an electrical connection having one or more wires, a portable computing device diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computing device readable storage medium may be any tangible medium that can contain or store a program for use by or in connection with an instruction execution system, apparatus, or device.

A computing device readable signal medium may include a propagated data signal with computing device readable program PIN embodied therein, for example, in baseband or as part of a carrier wave. Such a propagated signal may take any of a variety of forms, including, but not limited to, electro-magnetic, optical, or any suitable combination thereof. A computing device readable signal medium may be any computing device readable medium that is not a computing device readable storage medium and that can communicate, propagate, or transport a program for use by or in connection with an instruction execution system, apparatus, or device.

Program PIN embodied on a computing device readable medium may be transmitted using any appropriate medium, including but not limited to wireless, wire-line, optical fiber cable, radio frequency, etc., or any suitable combination of the foregoing. Computing device program PIN for carrying out operations for aspects of the present invention may be written in any combination of one or more programming languages, including an object oriented programming language such as Java, C#, C++ or the like and conventional procedural programming languages, such as the “C” programming language or similar programming languages.

Aspects of the present invention are described below with reference to flowchart illustrations and/or block diagrams of methods, apparatus (systems) and computing device program products according to embodiments of the invention. It will be understood that each block of the flowchart illustrations and/or block diagrams, and combinations of blocks in the flowchart illustrations and/or block diagrams, can be implemented by computing device program instructions. These computing device program instructions may be provided to a processor of a general purpose computing device, special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computing device program instructions may also be stored in a computing device readable medium that can direct a computing device, other programmable data processing apparatus, or other devices to function in a particular manner, such that the instructions stored in the computing device readable medium produce an article of manufacture including instructions which implement the function/act specified in the flowchart and/or block diagram block or blocks.

The computing device program instructions may also be loaded onto a computing device, other programmable data processing apparatus, or other devices to cause a series of operational steps to be performed on the computing device, other programmable apparatus or other devices to produce a computing device implemented process such that the instructions which execute on the computer or other programmable apparatus provide processes for implementing the functions/acts specified in the flowchart and/or block diagram block or blocks.

The term “communicatively coupled”, as used herein, generally refers to any coupling mechanism known in the art, such that at least one electrical signal may be transmitted between one device and one alternative device. Communicatively coupled may refer to Wi-Fi, Bluetooth, wired connections, wireless connection, and/or magnets. For ease of reference, the exemplary embodiment described herein refers to Wi-Fi and/or Bluetooth, but this description should not be interpreted as exclusionary of other electrical coupling mechanisms.

The term “Advantage Actor-Critic (A2C)” as used herein, generally refers to a reinforcement learning algorithm that employs two separate networks: an actor that decides which action to take, and a critic that evaluates the chosen action based on a given policy. The A2C algorithm may be particularly useful in multi-agent systems for coordinating agents in environments where the multi-agent system must adapt to other agents' actions.

The term “Altruistic Maneuver Planning” as used herein, generally refers to a strategy for autonomous vehicle decision-making that involves considering the utility of other vehicles, both autonomous and human-driven, to achieve socially-desirable outcomes. Altruism may be modeled as a distributed reward structure that accounts for both individual and collective objectives, allowing for cooperation among vehicles.

The term “Autonomous Vehicle (AV)” as used herein, generally refers to a vehicle capable of navigating without human input, relying on integrated vehicle navigation sensors, cameras, and/or computational algorithms to perceive its environment, make decisions, and/or execute maneuvers.

The term “Cooperative Multi-Agent System” as used herein, generally refers to a collection of multiple intelligent agents, such as autonomous vehicles, that coordinate actions to achieve a common goal. The Cooperative Multi-Agent System may involve the use of communication protocols, shared policies, and/or joint decision-making strategies that maximize collective rewards while minimizing conflict.

The term “Deep Reinforcement Learning (DRL)” as used herein, generally refers to a type of machine learning technique that combines neural networks with reinforcement learning principles to make sequential decisions. In the context of autonomous driving, DRL may be used to create policies for AVs to navigate safely and efficiently while adapting to dynamic traffic scenarios.

The term “Deep Q-Network (DQN)” as used herein, generally refers to a reinforcement learning algorithm that utilizes a deep neural network to approximate the optimal action-value function. DQN may be applied to determine the best action an AV should take based on the current state of the traffic environment, enabling more precise vehicle maneuvering.

The term “Decentralized Reward Structure” as used herein, generally refers to a reward system used in multi-agent reinforcement learning where each agent receives rewards based on local observations and actions. The decentralized approach may allow individual AVs to make decisions autonomously without requiring a central coordinating entity, enhancing scalability.

The term “Egoistic Agent” as used herein, generally refers to an autonomous vehicle that makes decisions solely based on optimizing its own individual utility, without consideration for the impact of its actions on other vehicles. Egoistic agents may be used as a benchmark to evaluate the benefits of altruistic and/or cooperative strategies.

The term “Hybrid Predictive Network (HPN)” as used herein, generally refers to a neural network architecture that combines an encoder-decoder model for the purpose of predicting future scenarios based on current and past observations. The HPN may aim to enhance AV decision-making by enabling accurate anticipation of future states in a traffic environment.

The term “Kinematic Prediction” as used herein, generally refers to the estimation of future positions, velocities, and orientations of vehicles based on their current kinematic states. Kinematic prediction may be an integral component in determining optimal actions for AVs, especially for predicting high-risk situations that require immediate action.

The term “Maneuver Planning” as used herein, generally refers to the process by which an autonomous vehicle selects a sequence of actions to achieve a specific driving objective, such as merging into traffic or avoiding obstacles. The Maneuver Planning may consider multiple factors, including safety, efficiency, and/or interactions with other road users.

The term “Mixed-Autonomy Environment” as used herein, generally refers to a traffic environment in which both autonomous vehicles and human-driven vehicles coexist.

The term “Multi-Agent Reinforcement Learning (MARL)” as used herein, generally refers to an extension of reinforcement learning that involves multiple agents, each learning a policy in a shared environment. In MARL, agents may be cooperative, competitive, or a combination of both, depending on the nature of the problem.

The term “Partially Observable Stochastic Game (POSG)” as used herein, generally refers to a framework for modeling interactions between multiple agents in an environment where each agent has only partial knowledge of the global state. POSG may be used in the context of AV navigation to represent scenarios where vehicles cannot fully observe the behaviors of other road users.

The term “Safe Tactical Decision-Making” as used herein, generally refers to the process by which autonomous vehicles determine safe maneuvers based on current traffic conditions, predicted future states, and safety constraints. This process may often involve penalizing high-risk actions and/or prioritizing safety in decision-making.

The term “Safety Prioritizer” as used herein, generally refers to a module within the AV's decision-making system that identifies and penalizes high-risk actions to prevent dangerous maneuvers. The Safety Prioritizer may act by masking unsafe actions from being selected, thereby improving overall safety during tactical decision-making.

The term “Social Coordination” as used herein, generally refers to the behavior of autonomous vehicles that involves cooperating with other vehicles, including both AVs and human-driven vehicles, to achieve socially optimal outcomes such as reduced congestion and improved safety. Social coordination may be facilitated through communication and shared policy frameworks.

The term “Social Value Orientation (SVO)” as used herein, generally refers to a metric used to quantify the level of altruism or selfishness displayed by an autonomous agent.

The SVO may determine how much an agent is willing to incorporate the utilities of other agents into its own decision-making process, thus impacting its driving behavior.

The term “Sympathetic Cooperative Reward Structure” as used herein, generally refers to a reward system that includes both cooperation among autonomous agents and sympathy towards human drivers. This reward structure may encourage AVs to make decisions that benefit all road users, taking into account the needs and safety of human drivers.

The term “Vehicle-to-Vehicle (V2V) Communication” as used herein, generally refers to the exchange of information between vehicles using wireless technology. V2V communication may allow AVs to share situational data, such as speed, position, and/or planned maneuvers, which may enhance collective decision-making and/or reduce uncertainty in mixed-autonomy environments.

The terms “about”, “approximately”, or “roughly”, as used herein, generally refer to being within an acceptable error range (i.e., tolerance) for the particular value as determined by one of ordinary skill in the art, which will depend in part on how the value is measured or determined (e.g., the limitations of a measurement system) (e.g., the degree of precision required for a particular purpose, such as providing altruistic maneuver planning for cooperative autonomous vehicles that sympathize with human drivers in human driven vehicles). As used herein, “about,” “approximately,” or “roughly” refer to within ±25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

Autonomous Vehicle Altruistic Maneuver Planning and/or Prediction Navigation System

The present invention pertains to a system and method for training, coordinating, and/or organizing altruistic maneuver vehicle navigation for cooperative autonomous vehicles that sympathize with human drivers in human driven vehicles (hereinafter “HVs”). The system and method may incorporate a cooperative sympathetic reward structure into a Multi-Agent Reinforcement Learning framework and/or may be configured to train agents that cooperate with each other, sympathize with human-driven vehicles, and/or consequently demonstrate superior performance in competitive driving scenarios, such as highway merging, compared to egoistically trained agents.

To further elaborate on the need for the system and method, assume the merging scenario depicted in FIG. 1A. In an embodiment, the merging vehicle, either HV and/or AV, may face a mixed-autonomy environment of AVs and/or HVs on the highway and/or may need them to slow-down to allow it to merge. If AVs act selfishly, it will be up to the HVs in the highway to allow for merging. Relying only on the human drivers can lead to sub-optimal or even unsafe situations due to their hard-to-predict and differing behaviors.

In this particular example, assuming egoistic AVs, the merging vehicle (MV) may either get stuck in the merging ramp and not be able to merge or will wait for an HV and/or risk on cutting into the highway without knowing if the HV will slow-down or not. On the other hand, altruistic AVs may work together and/or guide the traffic on the highway, e.g., by slowing down the vehicles behind as AV3, as shown in FIG. 1B, while AV1 and/or AV2 may be ordered to speed up creating an open space in order to enable a seamless and safe merging of MV. This situation can benefit both AVs and HVs. Such altruistic autonomous agents may create societally desirable outcomes in conflictive driving scenarios, without relying on or making assumptions about the behavior of human drivers.

Altruistic behavior of autonomous cars may be formalized by quantifying the willingness of each vehicle to incorporate the utility of others, whether an HV and/or an AV, into its local utility function. This notion is defined as social value orientation (SVO), which has recently been adopted from the psychology literature to robotics and artificial intelligence research. SVO determines the degree to which an agent acts egoistic or altruistic in the presence of others.

FIG. 1B depicts an example of altruistic behavior by Avs, according to an embodiment of the present disclosure, where they cooperate to create a safe corridor for the merging HV and enable a seamless merging. In a mixed-autonomy scenario, agents either may be homogeneous with the same SVO and/or may directly obtain each other's SVO (via V2V). However, the utility and/or SVO of an HV are unknowns, as they may be subjective and/or inconstant and therefore cannot be communicated to the AVs.

The existing social navigation works model a human driver's SVO either by predicting their behavior and avoiding conflicts with them or relying on the assumption that humans are naturally willing or can be incentivized to cooperate. By explicitly modeling human behavior, agents may exploit cooperation opportunities in order to achieve a social goal that favors both humans and autonomous agents.

However, modeling human behaviors is often challenging due to time-varying changes in the model affected by fatigue, distraction, and stress as well as scalability of belief modeling techniques over other agent's behaviors, hence limiting the practicality of the above approach. Methods based on model-predictive control (MPC) generally require an engineered cost function and a centralized coordinator. As such, they are not suitable for cooperative autonomous driving, where central coordination is not viable. On the other hand, data-driven solutions such as reinforcement learning are challenged in mixed-autonomy multi-agent systems, mainly due to the non-stationary environment in which agents are evolving concurrently.

Considering these shortcomings, the notion of altruism in AVs may be divided into cooperation within autonomous agents and sympathy among autonomous agents and human drivers. Dissociating the two components helps to separately probe their influence on achieving a social goal. One key insight is that defining a social utility function can induce altruism in decentralized autonomous agents and incentivize them to cooperate with each other and to sympathize with human drivers with no explicit coordination or information about the humans' SVO. The core differentiating component that the system relies on is that AVs trained to reach an optimal solution for all vehicles, learn to implicitly model the decision-making process of humans only from experience. The altruistic AVs behavior may be studied in scenarios that would turn into safety threats if either of sympathy and/or cooperation components is absent.

Multi-Agent Reinforcement Learning (MARL) may be a subfield of reinforcement learning (RL) where multiple learning agents interact with each other in a particular environment. Each agent makes decisions independently, and these decisions collectively define the state of the environment. In a MARL system, each agent learns a policy, which is a strategy to determine the action the agent should take based on its current state. The goal of each agent is typically to maximize its own cumulative reward over time. The reward can depend not only on the actions of the agent itself but also on the actions of other agents. One of the key challenges in MARL is the continuously changing environment: because all agents are learning and updating their policies simultaneously, the environment effectively changes as each agent learns. This is often referred to as the “non-stationarity” problem in MARL.

Driving styles of humans can be learned from demonstration through inverse RL or employing various well-known statistical models known in the art such as those disclosed by D. Sadigh, S. Sastry, S. A. Seshia, and A. D. Dragan, “Planning for autonomous cars that leverage effects on human actions.” in Robotics: Science and Systems, vol. 2. Ann Arbor, MI, USA, 2016; H. N. Mahjoub, B. Toghi, and Y. P. Fallah, “A driver behavior modeling structure based on non-parametric Bayesian stochastic hybrid architecture,” in 2018 IEEE 88th Vehicular Technology Conference (VTC-Fall), 2018, pp. 1-5; and H. N. Mahjoub, B. Toghi, and Y. P. Fallah “A stochastic hybrid framework for driver behavior modeling based on hierarchical Dirichlet process,” in 2018 IEEE 88th Vehicular Technology Conference (VTC-Fall), 2018, pp. 1-5.

Modeling human driver behavior assists autonomous vehicles to identify potentials for creating cooperation and interaction opportunities with humans in order to realize safe and efficient navigation. Moreover, human drivers may be able to intuitively anticipate next actions of neighboring vehicles through observing slight changes in their trajectories and leverage the prediction to move proactively if required. Inspired by this fact, Sadigh et al. in “Planning for autonomous cars that leverage effects on human actions.” in Robotics: Science and Systems, vol. 2. Ann Arbor, MI, USA, 2016 reveal how autonomous vehicles can exploit this farsighted behavior of humans to shape and affect their actions. On a macro-traffic level, prior works have demonstrated emerging human behaviors within mixed-autonomy scenarios and studied how these patterns can be utilized to control and stabilize the traffic flow. Recent works in social robot navigation have shown the potential for collaborative planning and interaction with humans as well.

Among the recent publications in the MARL literature, Foerster, G. Farquhar, T. Afouras, N. Nardelli, and S. Whiteson, “Counterfactual multi-agent policy gradients,” in Proceedings of the AAAI Conference on Artificial Intelligence, vol. 32, no. 1, 2018 and R. Lowe, Y. Wu, A. Tamar, J. Harb, P. Abbeel, and I. Mordatch, “Multi-agent actor-critic for mixed cooperative-competitive environments,” arXiv preprint arXiv:1706.02275, 2017 significantly contributed to solving multi-agent cooperative-competitive problems. J. Foerster et al. in their paper above propose the counterfactual multi-agent (COMA) algorithm that is expected to address the credit assignment problem in multi-agent environments. The COMA algorithm utilizes the set of joint actions of all agents as well as the full state of the world during the training. A global centralized reward function is then used to calculate the agent-specific advantage function. In contrast, the system may be configured to assume partial observability and a decentralized reward function during both training and execution that is expected to promote cooperative and sympathetic behavior among autonomous vehicles. presents a general-purpose multi-agent learning algorithm that enables agents to conquer simple cooperative-competitive games with access to local observations of the agents. An adaptation of actor-critic methods with a centralized action-value function is employed that uses the set of actions of all agents and local observations as its input. However, the agents do not have access to the actions of their allies and/or opponents.

As examples of more practical related works, the reader can refer to the multi-agent learning framework presented in P. Palanisamy, “Multi-agent connected autonomous driving using deep reinforcement learning,” in 2020 International Joint Conference on Neural Networks (IJCNN). IEEE, 2020, pp. 1-7 that enables connected autonomous vehicles with shared observations and policy to navigate through a stop sign-controlled urban intersection. The focus is not on the interaction with humans and it rather provides a practical framework for future studies. The multi-agent DQN in J. K. Gupta, M. Egorov, and M. Kochenderfer, “Cooperative multi-agent control using deep reinforcement learning,” in International Conference on Autonomous Agents and Multiagent Systems. Springer, 2017, pp. 66-83 and M. Egorov, “Multi-agent deep reinforcement learning,” CS231n: convolutional neural networks for visual recognition, pp. 1-8, 2016 is trained to solve a grid-world pursuit-evasion game. In addition, a central controller may also be utilized with full observability over the environment and global reward function that produces joint-actions for all agents.

Importantly, the existing literature on multi-agent systems focuses on solving cooperative and competitive problems by making assumptions on the nature of interactions between agents (or agents and humans). However, in the present case, the system may be concerned with the emerging sympathetic operative behavior that enables the agents to cooperate among themselves as well as with their competitors, i.e., humans.

Modeling human driver behavior assists autonomous vehicles to identify potentials for creating cooperation and interaction opportunities with humans in order to realize safe and efficient navigation. Driving styles of humans can be learned either from demonstration through inverse RL, as illustrated in M. Kuderer, S. Gulati, and W. Burgard, “Learning driving styles for autonomous vehicles from demonstration,” in 2015 IEEE International Conference on Robotics and Automation (ICRA). IEEE, 2015, pp. 2641-2646 and D. Sadigh, N. Landolfi, S. S. Sastry, S. A. Seshia, and A. D. Dragan, “Planning for cars that coordinate with people: leveraging effects on human actions for planning and active information gathering over human internal state,” Autonomous Robots, vol. 42, no. 7, pp. 1405-1426, 2018 and/or employing statistical models such as Gaussian and Dirichlet processes.

Human drivers are able to intuitively anticipate next actions of neighboring vehicles through observing slight changes in their trajectories and leverage the prediction to move proactively if required. Inspired by this fact, it has been demonstrated within the incorporated references how autonomous vehicles can model this farsighted behavior in humans and exploit that to manipulate and affect the actions of human-driven vehicles.

Recent works in social navigation have revealed the potential for collaborative planning and interaction with humans. Examples include but not limited to P. Trautman and A. Krause, “Unfreezing the robot: Navigation in dense, interacting crowds,” in 2010 IEEE/RSJ International Conference on Intelligent Robots and Systems. IEEE, 2010, pp. 797-803. and S. Nikolaidis, R. Ramakrishnan, K. Gu, and J. Shah, “Efficient model learning from joint-action demonstrations for human-robot collaborative tasks,” in 2015 10th ACM/IEEE International Conference on Human-Robot Interaction (HRI). IEEE, 2015, pp. 189-196 where a common reward function is optimized in order to enable joint trajectory planning for humans and robots. Recent data-driven approaches have shown achievements in classifying human driving maneuvers, or predicting human trajectories to enable fully autonomous navigation of a robot in human-dense environments by employing deep reinforcement learning. As such, the system may be configured to integrate a Sym Co Drive as a solution that incentivizes autonomous vehicles to cooperate and sympathize with humans with no explicit information about humans' SVO and potential reactions.

It is helpful to formulate the problem of multi-vehicle interaction using a stochastic game defined by the tuple:

$${ℳ}_{G} := ( I , 𝒮 , [ {𝒜}_{i} ] , [ {𝒪}_{i} ] , P , [ {r}_{i} ] ) \qquad ( 1 )$$

In which “I” is a finite set of agents and 8 represents the state-space including all possible formations that the N agents can adopt.

At a given time the agent receives a local observation oᵢ: [symbol] → [symbol] and takes an action within the action-space ai∈Ai based on a stochastic policy Tri: πᵢ: [symbol] × [symbol] →[0,1]. Consequently, the agent transits to a new state, s′ᵢ, which is determined based on the state transition function Pr(s′|s, a): [symbol] × [symbol] ₁× . . . × [symbol] → [symbol] and receives a reward rᵢ: [symbol] × [symbol] →R. The goal is to derive an optimal policy π* that maximizes the discounted sum of future rewards over an infinite time horizon.

In a partially-observable stochastic game (POSG), the state transition and reward functions are usually not known and an agent only has access to a local observation which is correlated with the state. Employing multi-agent reinforcement learning, independent MARL agents can work together to overcome the physical limitations of a single agent and outperform them.¹⁴ In a multi-vehicle problem, controlling vehicles by a centralized MARL controller that has full observability over the environment and assigns a centralized joint reward ∀i,j:rᵢ≡rⱼ to all vehicles is rather straightforward. Coordination among agents in such settings is expected to arise from the introduced decentralized reward function, which uses the local observations, via a plurality of vehicle navigation sensors of the AV, to estimate the utility of other vehicles.

Q-learning, which has been widely applied in reinforcement learning problems with large state-spaces, defines a state-value function Q^{π}(s,a)=E[Σᵢ₌₁^{∞}YⁱRᵢ(sᵢ,π(sᵢ))|s₀=s, a₀=a],to derive the optimal policy π*(s)=arg max Q*(s, a) where γ∈[0,1) is a discount factor. DQN¹⁵ uses a neural network with weights w to estimate the state-action value function by performing mini-batch gradient descent steps as wᵢ₊₁=wᵢ+aᵢ [symbol] (wᵢ) where the loss function is defined as:

$$ℒ ( {w}_{i} ) = 𝔼 [ ( r + γ {max}_{a} {Q}^{*} ( {s}^{′} , {a}^{′} ; w ° ) - {{Q}^{*} ( s , a ; w )}^{2} ] \qquad ( 2 )$$

Where the V̅_{w} operator is an estimate of the gradient at wi and w° is the target network's weights which get updated periodically in training. Sets of (s, a, r, s′) are randomly drawn from an experience replay buffer to de-correlate the training samples in Equation (1). This mechanism becomes problematic when agents' policies evolve during the training.

A base scenario is a highway merging ramp where a merging vehicle (MV) (either HV or AV) attempts to join a mixed autonomy environment of HVs and AVs, as illustrated in FIG. 1A and FIG. 1B. This scenario is chosen due to its inherent competitive nature since the local utility of the merging vehicle is conflictive with that of the cruising vehicles. It is assumed that only one AV yielding to the merging vehicle will not make the merge possible and for it to happen, essentially all AVs are required to work together. In FIG. 1B, AV3 must slow down and guide the vehicles behind it, which perhaps are not able to see the merging vehicle, while AV2 and AV1 speed-up to open space for the merging vehicle. If any of the vehicles do not cooperate or act selfishly, traffic safety and efficiency will be compromised.

Consider a road section as shown in FIG. 1A and FIG. 1B with a set of autonomous vehicles I, a set of human-driven vehicles V, and a merging vehicle, M∈I∪V that can be either AV or HV and is attempting to merge into the highway. HVs normally have a limited perception range restricted by occlusion and obstacles. In the case of AVs, although assuming no explicit coordination and no information about the actions of the others, autonomous agents are connected through V2V communication which allows them to share their situational awareness. Leveraging this extended situational awareness, agents can broaden their range of perception and overcome occlusion and line-of-sight visibility limitations. Therefore, while each AV has a unique partial observation of the environment, they can see all vehicles within their extended perception range, i.e., they can see a subset of AVs I_{e⊂}I, and a subset of HVs V e⊂V.

In order to model a mixed-autonomy scenario, in an embodiment, the system may deploy a mixed group of HVs and/or AVs to cruise on a highway and target to maximize their speed while maintaining safety. The contrast between human and autonomous agents is that humans are solely concerned about their own safety while the altruistic autonomous agents attempt to optimize for the safety and efficiency of the group. Social value orientation gauges the level of altruism in an agent's behavior. In order to systematically map the interaction between agents and humans, it may be necessary to decouple the notion of sympathy and/or cooperation in SVO. Specifically, one considers the altruistic behavior of an agent with humans as sympathy and refers to the altruistic behavior among agents themselves as cooperation. One rationale behind this definition is the fact that the two are different in nature as the sympathetic behavior can be one-sided when humans are not necessarily willing to help the agents. Cooperation, however, is a symmetric quality since the same policy is deployed in all AVs and as will be seen in the experiments set out herein, the social goal of the group can be achieved regardless of the humans' willingness to cooperate.

A Decentralized Reward Structure. The local reward received by agent Iᵢ∈I can be decomposed to:

$${R}_{i} ( {s}_{i} , {a}_{i} ) = {R}^{E} + {R}^{C} + {R}^{S} = {λ}^{E} {r}_{i}^{E} ( {s}_{i} , {a}_{i} ) + {λ}^{C} {\sum }_{j} {r}_{i , j}^{C} ( {s}_{i} , {a}_{i} ) + {λ}^{S} {\sum }_{k} {r}_{i , k}^{S} ( {s}_{i} , {a}_{i} ) \qquad ( 3 )$$

in which j∈Ĩ\Iᵢ, k∈(\tilde{V}∪M)\(I∩M). The level of altruism or egoism can be tuned by λ^{E}, λC, and λ^{S} coefficients. The rᵢ^{E} component in Equation (3) denotes the local driving performance reward derived from metrics such as distance traveled, average speed, and a negative cost for changes in acceleration to promote a smooth and efficient movement by the vehicle. The cooperative reward term, r C_{i,j} accounts for the utility of the observer agent's allies, i.e., other AVs in the perception range except for Iᵢ. It is important to note that Iᵢ only requires the V2V information to compute R^{C} and not any explicit coordination or knowledge of the actions of the other agents. The sympathetic reward term, r_{i,k}^{S} is defined as follows:

$${r}_{i , k}^{S} = {r}_{k}^{M} + {\sum }_{k} \frac{1}{η {d}_{i , k}^{ψ}} {u}_{k ′} \qquad ( 4 )$$

Where uk denotes an HV's utility, e.g., its speed, _{di,k} is the distance between the observer autonomous agent and the HV, and η and ψ are dimensionless coefficients. Moreover, the sparse scenario-specific mission reward term rₖ^{M} in the case of the driving scenario is representing the success or failure of the merging maneuver, formally:

$${r}_{k}^{M} = \{ \begin{matrix}1 , & if {V}_{k} is the mission vehicle and has merged \\ 0 , & o . w .\end{matrix} \qquad ( 5 )$$

During training, each agent optimizes for this decentralized reward function using Deep RL and learns to drive on the highway and work with its allies to create societally desirable formations that benefits both AVs and HVs.

State-space and Action-space. The robot navigation problem can be viewed from multiple levels of abstraction: from the low-level continuous control problem to the higher-level meta-action planning. One purpose of the system is to study the inter-agent and agent-human interactions as well as the behavioral aspects of mixed-autonomy driving. Thus, a more abstract level is chosen to define the action-space as a set of discrete meta-actions ai∈Rⁿ.

The multi-channel velocity map representation, as shown in FIG. 2, separates AVs and HVs into two channels respectively and embeds their relative speed in the pixel values. As such, FIG. 2 depicts an example of a multi-channel representation, according to an embodiment of the present disclosure. In this manner, a clipped logarithmic function may be used to map the relative speed of the vehicles into pixel values as it showed a better performance compared to the linear mapping, i.e.,

$${Z}_{j} = 1 - β log ( α \vert {v}_{j}^{( l )} \vert ) 1 ( \vert {v}_{j}^{( l )} \vert - {v}_{0} ) \qquad ( 6 )$$

Where Zj represents the pixel value of the jth vehicle in the state representation, v^{(l)} represents its relative Frenet longitudinal speed from the kth vehicle's point-of-view, i.e., Ij−Ik, v0 represents speed threshold, α and/or β represents dimensionless coefficients, and/or 1(·) represents the Heaviside step function. Such non-linear mapping gives more importance to neighboring vehicles with smaller |v(^{l}I| and almost disregards the ones that are moving either much faster or much slower than the ego. Three more channels were added to the system that embed 1) the road layout, 2) an attention map to emphasize on the location of the ego, and 3) the mission vehicle

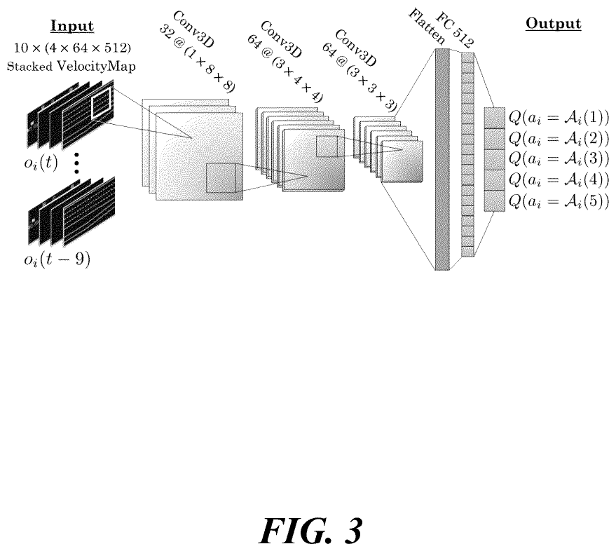

The other representation candidate is an occupancy grid representation, FIG. 3, that directly embeds the information as elements of a 3-dimensional tensor oᵢ∈Oᵢ.

Theoretically, this representation is very similar to the previous velocity map of FIG. 2 and what contrasts them is that the occupancy grid removes the shapes and visual features such as edges and corners and directly feeds the network with sparse numbers.

More specifically, consider a tensor of size W×H×F, in which the nth channel is a W×H matrix defined as

$${o}_{( n , , )} ∈ {ℝ}^{2} = \{ \begin{matrix}f ( n ) , & if f ( 1 ) = 1 \\ 0 , & o . w .\end{matrix} \qquad ( 7 )$$

Where f=[p, l, d, v^{(l)}, v(^{d}), sin 8, cos 8] represents the feature set, p represents a binary variable showing the presence of a vehicle, l and d represent relative Frenet coordinates, v^{(l)} and v^{(d)} represent relative Frenet speeds, and 8 represent the yaw angle measured with respect to a global reference

Training with Deep MARL:

Additionally, in an embodiment, the system may comprise at least one 3D convolutional network configured to capture the temporal dependencies in a training episode, as shown in FIG. 3. The input to the network may comprise a stack of 10 Velocity Map observations, i.e., a 10×(4×512×64) tensor, which capture the last 10 time-steps in the episode.

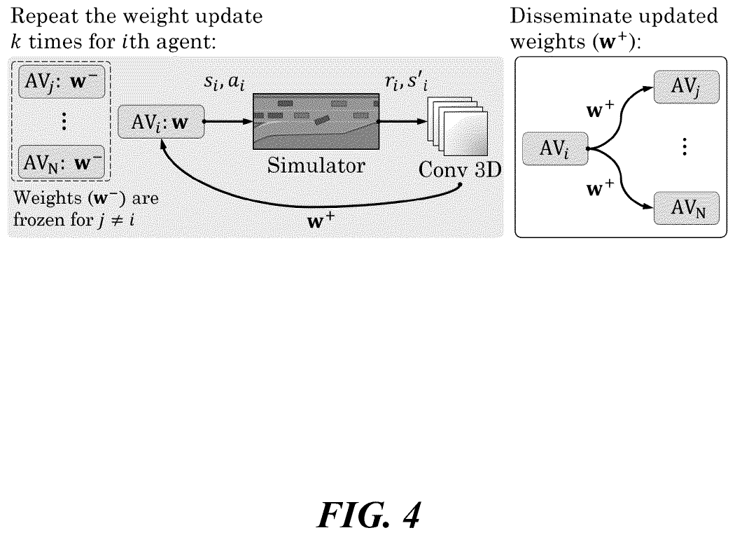

In this manner, in an embodiment, one process may train a single neural network offline and/oy may deploy the learned policy to all agents for distributed independent execution in real-time. In order to cope with the non-stationarity issue in MARL, agents may also be trained in a semi-sequential manner, as illustrated by the process in FIG. 4. As such, each agent may be trained separately for k episodes while the policies of its allies, w⁻, may be frozen. The new policy, w⁺, may be then disseminated to all agents to update their neural networks.

Additionally, the system may also disclose a novel experience replay mechanism to compensate for highly skewed training data. A training episode (in the context of vehicle merging onto a highway for example) of the system may be semantically divided into two sections: (1) cruising on a straight highway; and/or (2) highway merging. The ratio of the latter to the former in the experience replay buffer may be a small number since the latter occurs in only a short time period of each episode. Consequently, uniformly sampling from the experience replay buffer leads to too few training samples relating to highway merging. Instead, the probability of a sample being drawn from the buffer is set proportional to its last resulted reward and its spatial distance with the merging point on the road. Balancing skewed training datasets may be a common practice in computer vision and/or machine learning and appeared to be beneficial in a MARL problem as well.

Additionally, in an embodiment, the system may comprise an artificial intelligence algorithm (e.g., OpenAI Gym) environment to simulate highway driving and/or merging scenarios. In the framework of the simulator, in this embodiment, a model (e.g., a Kinematic Bicycle Model) may describe the motion of the vehicles and/or a closed-loop proportional-integral-derivative (hereinafter “PID”) controller may be communicatively coupled to the system, such that the controller may be employed for translating the meta-actions to low-level steering and acceleration control signals.

Particularly, in an embodiment a set of abstract actions (e.g., n=5 abstract actions) may be chosen as Ai (e.g., ∈Ai=[Lane Left, Idle, Lane Right, Accelerate, Decelerate]^{T}). As a common practice in the autonomous driving space, segments and/or vehicles' motion may be expressed in the Frenet-Serret coordinate frame which helps to take the road curvature out of the equations and/or break-down the control problem to lateral and/or longitudinal components. In the simulated environment of the system, in this embodiment, the behavior of HVs may be governed by lateral and longitudinal driver models proposed by Treiber et al. and Kesting et al.

In an embodiment, in order to ensure the generalization capability of the learned policies according to one aspect of the system, the initial position of all vehicles may be prepared from a clipped Gaussian distribution with mean and/or variance tuned to ensure that the initialized simulations fall into the desired merging scenario configuration. The speed and/or initial position of the vehicles may be further randomized during the testing phase to probe the agents' ability to handle unseen and/or more challenging cases.

Moreover, in an embodiment, a single training iteration in the implementation (e.g., PyTorch implementation) of the training processes may require at least one processor of a computing device having specifications comprising a range of about 250 ms to about 800 ms. For example, in some embodiments, the SymCoDrive of the at least one processor may take about 440 ms using a NVIDIA Tesla V100 GPU and/or a Xeon 6126 CPU@2.60 GHz.

In this manner, the training process may be repeated multiple times to ensure all runs converge to similar emerging behaviors and/or policy. The policy execution frequency may be set to 1 Hz and/or an online query of the network in the testing phase takes approximately 10 ms. For example, in some embodiments, about 4,650 GPU-hours of computational time may be spent to tune the neural networks and/or reward coefficients for the purpose of the experiments.

Furthermore, in an embodiment, the system may be configured to conduct a set of experiments on how sympathy and/or cooperation components of the reward function may impact the behavior of autonomous agents and the overall safety/efficiency metrics.

The system may compare the case in which the mission vehicle—merging vehicle, as shown in the example in FIG. 1—is autonomous to its dual scenario with a human-driven mission vehicle. The defined 2×4 settings, in which the mission vehicle is either an AV or HV, and/or the other autonomous agents follow an egoistic, cooperative-only, sympathetic-only, or sympathetic cooperative objectives:
HV+E. The mission vehicle is human-driven and autonomous agents act egoistically,
HV+C. The mission vehicle is human-driven and autonomous agents only have a cooperation component (R^{C}) in their reward,
HV+S. The mission vehicle is human-driven and autonomous agents only have the sympathy (R^{S}) element,
HV+SC. The mission vehicle is human-driven and autonomous agents have both sympathy (R^{S}) and cooperation (R^{C}) components in their reward, and
V+E/C/S/SC. Similar to the cases above with the difference of mission vehicle being autonomous.

The average distance traveled by each vehicle within the duration of a simulation episode may be a traffic-level measure for efficiency. The percentage of the episodes that experienced a crash may indicate the safety of the policy. Counting the number of scenarios with no crashes and/or successful missions (merging to the highway) may provide the system an idea about the solution's overall efficacy.

In an embodiment, at least three hypotheses may be examined with the system:
H1. In the absence of both cooperation and sympathy, a HV may not be able to safely merge into the highway. Thus, it may be anticipated to witness a better performance in HV+SC compared to HV+C and HV+E.
H2. An autonomous mission vehicle may only require altruism from its allies to successfully merge. It is not expected to see a significant difference between AV+SC and AV+C scenarios; however, it may be hypothesized that both will outperform AV+E.
H3. Tuning the level of altruism in agents may lead to different emerging behaviors that contrast in their impact on efficiency and/or safety. Increasing the level of altruism may become self-defeating as it jeopardizes the agent's ability to learn the basic driving skills.

As such, in an embodiment, the model (e.g., SymCoDrive) may comprise a plurality of agents, such that the plurality of agents may be trained for about 15,000 episodes in randomly initialized scenarios with a small standard deviation and/or average the performance metrics over about 3,000 test episodes with about 4× larger initialization range to ensure that the agents are not over-fitting on the seen training episodes.

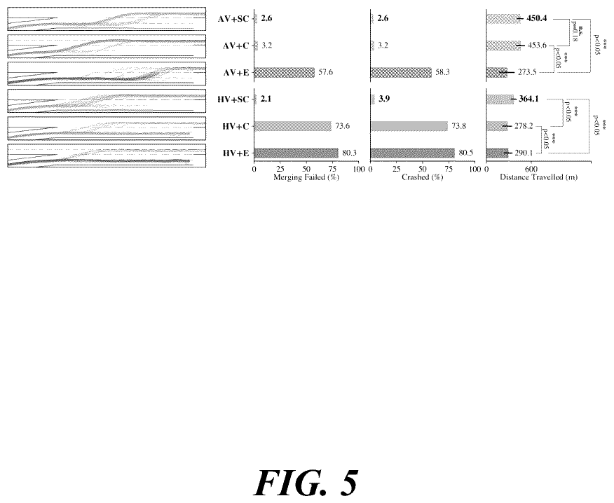

In an embodiment, to examine the hypothesis H1, the system may implement human-driven mission vehicle scenarios (e.g., HV+E, HV+C, and/or HV+SC). FIG. 5 depicts observations for these scenarios, according to an embodiment of the present disclosure. As such, it may be evident that the plurality of agents that integrate cooperation and/or sympathy elements (SC) in their reward functions show superior performance compared to solely cooperative (C) and/or egoistic (E) agents. This insight may also be reflected in the bar plots that measure the average distance traveled by vehicles on the bottom right-most side. As a result of fair and/or efficient traffic flow, vehicles in the HV+SC scenario clearly succeed to travel a longer distance whereas in the HV+C (54) and/or HV+E scenarios failed merging attempts and possible crashes deteriorate the performance. The left-most column in FIG. 5 visualizes a set of sampled mission vehicle trajectories. It is clear that in the majority of episodes, cooperative sympathetic agents may successfully merge to the highway while the other (C) and/or (E) agents fail in most of their attempts.

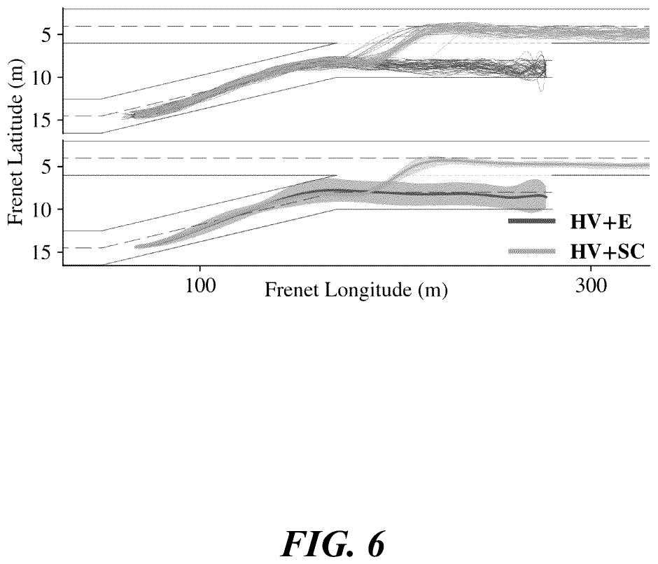

FIG. 6 provides further intuition by comparing a set of mission vehicle's trajectories extracted from a HV+E scenario to the trajectories from the HV+SC scenario. Evidently, the plurality of cooperative sympathetic agents may enable successful merging while the other egoistic and/or solely-cooperative agents fail to do so, supporting hypothesis H1.

In an embodiment, the system may be configured to repeat the above experiments for scenarios with an autonomous mission vehicle. As such, in this embodiment, AV+E, AV+C, and AV+SC scenarios are illustrated in the top 3 rows of FIG. 5. First, a comparison between two scenarios with egoistic agents, i.e., AV+E and HV+E, may unveil that an autonomous mission vehicle may act more creatively and/or may explore different ways of merging to the highway, hence the more spread trajectory samples in AV+E compared to HV+E. Next, comparing the performance of an egoistic autonomous mission vehicle with a human-driven mission vehicle in terms of crashes and failed merges shows the autonomous agent may be generally more capable to find a way to merge into the platoon of humans and egoistic agents. However, it still fails in more than half of its merging attempts. FIG. 5 verifies hypothesis H2 as it can be observed that adding only a cooperation component to the agents, i.e., AV+C (60) scenario, enables the mission vehicle to merge to the highway almost in all of its attempts. Adding the sympathy element in AV+SC slightly improves the safety as it incentivizes the agents to be aware of the humans that are not in the direct risk of collision with them.

### Tuning Altruism & Emerging Behaviors:

To investigate hypothesis H3, the system may be configured to train a set of agents and vary their reward coefficients, i.e., AE, AC, AS, to adjust their level of sympathy and cooperation. Revisiting the driving scenario depicted in FIG. 1A and FIG. 1B, two critical emerging behaviors were witnessed in agents. Strongly sympathetic agents that are trained with a high ratio of AS/(AC+AE), naturally prioritize the benefit of humans over their own.

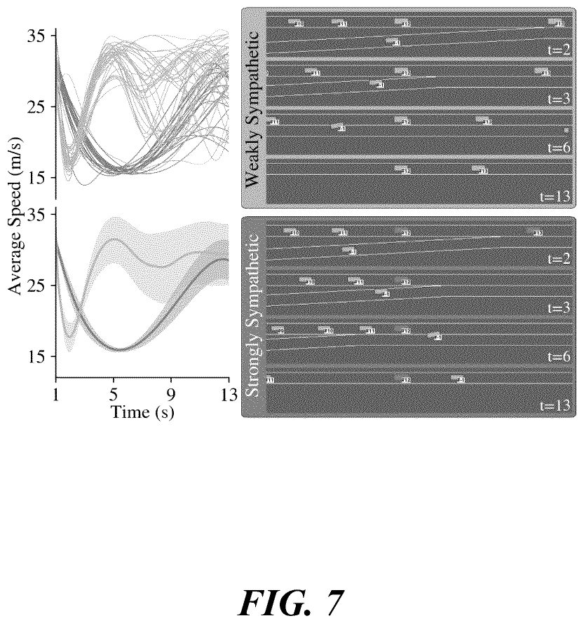

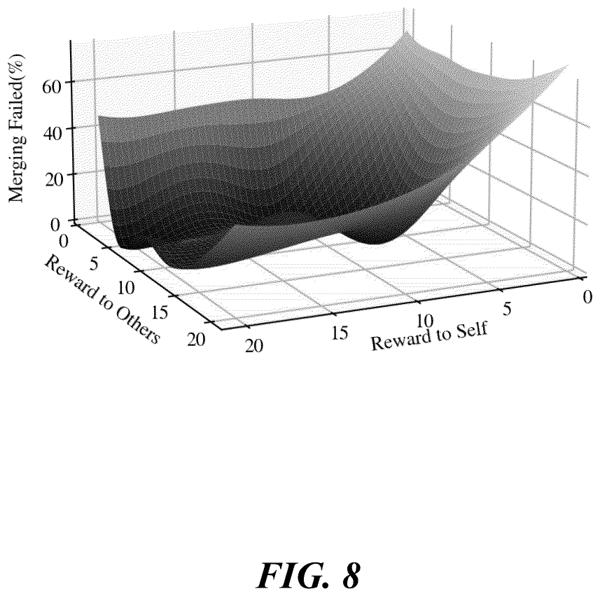

FIG. 7 shows a set of snapshots extracted from two scenarios with strongly sympathetic and weakly sympathetic agents. A strongly sympathetic agent (consider AV3 in FIG. 1B) slows down and blocks the group of vehicles behind it to ensure that the mission vehicle gets a safe pathway to merge. On the other hand, the weakly sympathetic agent initially brakes to slow down the group of the vehicles behind it and then prioritizes its own benefit, speeds up, and passes the mission vehicle. Although both behaviors enable the mission vehicle to successfully merge, the speed profiles of the agent in FIG. 7 depict how a strongly sympathetic agent compromises on its traveled distance (the area under the speed curve) to maximize the mission vehicle's safety. As illustrated in FIG. 8, it is empirically observed that an optimal point between caring about others and being selfish exists that eventually benefits all the vehicles in the group.

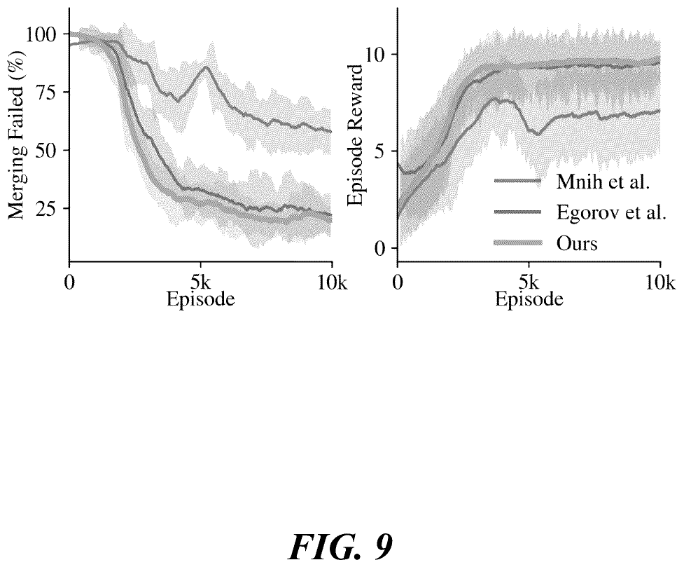

FIG. 9 depicts the training performance of the networks, according to an embodiment of the present disclosure. In an embodiment, when tested in episodes with the same range of initialization randomness as training, all networks showed acceptable performance. However, their performance quickly depreciated when the range of randomness was increased and agents faced episodes different than what they had seen during the training, as noted in TABLE 1 below. While the other networks over-fitted on the training episodes, the inventor's Conv3D architecture significantly outperformed them in the more diverse test scenarios. By using Velocity Maps and Conv3D architecture, the agents may learn to handle more complex unseen driving scenarios. TABLE 2 lists the hyper-parameters used to train a Conv3D architecture.

The Occupancy Grid state-space representation, as defined in Equation (6), showed an inferior performance in all neural network architectures compared to the Velocity Map representation in the exemplary particular driving problem. In this manner, the Occupancy Grid representation does not benefit from the road layout and visual cues embedded in the Velocity Map state representation. All of the experiments discussed earlier are performed with Velocity Map representation, unless stated otherwise. After tuning the VelocityMaps, a hard ego-attention map integrated within the state representation did not make a significant enhancement and decided to drop this channel, reducing the number of channels to 4. Instead, the center of VelocityMaps was aligned with regards to the ego such that 30% of the observation frame reflects the range behind the ego and the rest shows the range in front. It was noticed that this parameter plays an important role in training convergence and the resulted behaviors as it enables the agent to see the mission vehicle and other vehicles before they get to its close proximity.

TABLE 1

| | Low Randomness | | | Medium Randomness | | | High Randomness | | |
|---|---|---|---|---|---|---|---|---|---|
| Models | C (%) | MF (%) | DT (m) | C (%) | MF (%) | DT (m) | C (%) | MF (%) | DT (m) |
| Toghi et al. | 6.2 | 0 | 288 | 65.2 | 65.2 | 304 | 78.9 | 31.4 | 212 |
| Mnih et al. | 9.6 | 7.2 | 350 | 41.2 | 41.2 | 240 | 12.9 | 10.8 | 344 |
| Egorov et al. | 19.7 | 9.0 | 312 | 7.3 | 1.7 | 366 | 18.9 | 8.4 | 313 |
| Conv3D (Ours) | 3.3 | 0.2 | 334 | 2.4 | 0.4 | 373 | 4.8 | 1.0 | 351 |

C: Crashed,
MF: Merging Failed,
DT: Distance Travelled

TABLE 2

| Hyper-param | Value |
|---|---|
| Training iterations | 720,000 |
| Batch size | 32 |
| Replay buffer size | 10,000 |
| Learning rate | 0.0005 |
| Target network update | 200 |
| Initial exploration | 1.0 |
| Final exploration | 0.1 |
| ϵ decay | Linear |
| Optimizer | ADAM |
| Discount factor γ | 0.95 |

As such, the system may be configured to tackle the problem of autonomous driving in mixed-autonomy environments where autonomous vehicles interact with vehicles driven by humans. The system may also incorporate a cooperative sympathetic reward structure into the MARL framework and trains the agents that cooperate with each other, sympathize with human-driven vehicles, and/or consequently demonstrate superior performance in competitive driving scenarios, such as highway merging, compared to egoistically trained agents.

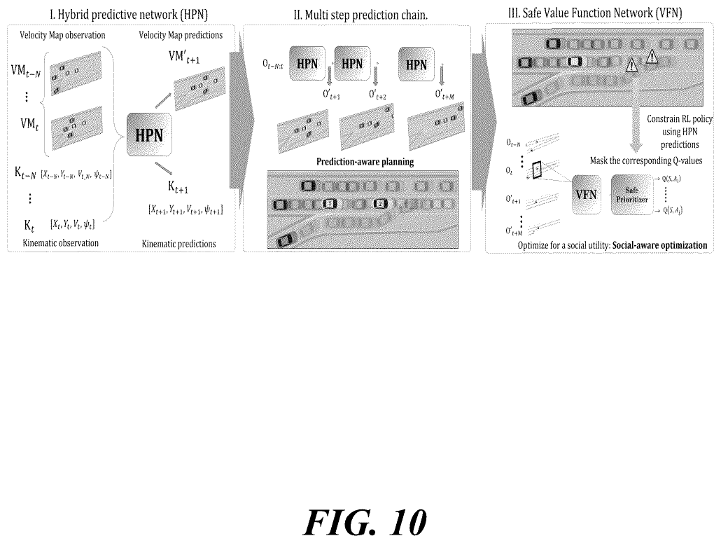

Additionally, another aspect of the present disclosure pertains to the system and method comprising a Hybrid Predictive Network (hereinafter “HPN”) and/or a Value Function Network (hereinafter “VFN”), along with a safety prioritizer, to enhance decision-making and safety. FIG. 10 depicts an overview of the hybrid predictive system. Accordingly, first, in an embodiment, the system may comprise the Hybrid Predictive Network that may intend to provide AVs the ability to predict other agents' potential future, as shown in FIG. 10. Second, the HPN may be used in a multi-step prediction chain that delivers a window of predicted observations to the Value Function Network (as shown in FIG. 10). Finally, the safe VFN may rely on a decentralized cooperative RL architecture that optimizes for a social utility and uses expressive velocity map predictions as part of the input states and interpretable kinematic predictions for a safety prioritizer. The safety prioritizer may also use the kinematic predictions from the multi-step HPN to constrain the RL policy to ensure safety decision-making by masking the Q-states that produce unsafe results, as shown in FIG. 10. As such, the prediction-aware and/or social-aware AV may be evaluated with related approaches under a variety of settings and show that, given the ability to forecast future observations, the AVs may use the proposed system and method to improve safety, efficiency, and/or overall traffic flow.

As such, in an embodiment, the system may comprise the following:
(A) A prediction-aware, social-aware decentralized cooperative RL framework may be presented and/or the altruistic cooperative driving problem as a Partially Observable Stochastic Game (POSG) may be formalized.
(B) A hybrid predictive network may be presented that provides AVs the ability to anticipate future observations and use it in a multi-step prediction chain that delivers multiple future observations to the value function network.
(C) A robust safety prioritizer may be described that uses interpretable kinematic predictions from the HPN to minimize future high-risk actions, constraining the RL policy to ensure safe decision-making, enhancing awareness of the imminent hazards, reducing collisions, and/or accelerating the learning process.

In an embodiment, the system may also comprise an autoencoder (hereinafter “AE”), such that the AE may comprise a neural network that is trained in an unsupervised approach to minimize the reconstruction error. The AE may be configured to learn important features that allow reconstruction of the original input and its architecture may be generally divided into two main components: an encoder and/or a decoder. Following a similar approach, an AE may be trained for a prediction task assuming that the state at time t and the corresponding state at time t+1. Formally, the encoder maps the input x to a latent feature representation z denoted by z=f_{w}_{ₑ}(x). The decoder may use the latent representation z to obtain a reconstruction y of the input x, denoted by y=f_{w}_{_{d}}(z). reconstruction error, i.e., the difference between x and the reconstruction y is used as the objective function.

Gaussian processes (hereinafter “GP”) may be frequently used to predict future trajectory time series by regressing the observed time-series realizations from history, capturing the distinct patterns as they emerge in the data, making GP a useful tool for detecting patterns in time series. When using GP to forecast future trajectories, the set of m observed values may represented by an m-dimensional multivariate Gaussian random vector, described by an m×m covariance matrix and a m mean vector. This covariance matrix, often known as the GP kernel, is the foundation upon which GP detects and anticipates the underlying behavior of time series based on their recorded history. The fundamental GP components can be expressed mathematically as follows:

$$f ( t ) ∼ gpm ( t ) , k ( t , {t}^{′} ) , \qquad ( 8 )$$

$${\{ {x}_{i} \}}_{i = 1 , 2 , … m} = {\{ f ( {t}_{i} ) \}}_{i = 1 , 2 , … m} ∼ N ( μ , \sum ) , \qquad ( 9 )$$

$$μ = m ( {t}_{i} ) , … , {m ( {t}_{m} )}^{T} , \qquad ( 10 )$$

$${\sum }_{i} = κ ( {t}_{i} , {t}_{j} ) ∀ i , j ϵ \{ 1 , 2 , … , m \} \qquad ( 11 )$$

Where Xᵢ, f (t), m(.), and K (.,.) represent the samples of the vehicles' state, observed and/or to be predicted at the time tᵢ, the unknown underlying function that the vehicles' states are sampled from, the mean and the covariance functions, respectively.

Additionally, the GP may be leveraged to improve kinematics prediction, and instead of working directly with the position time series, the GP inference algorithm treats the vehicles' heading and longitudinal speed as two independent time series that are regressed using GPs, and then using the predicted heading and longitudinal speed, the vehicles' positions are calculated. A model built using a non-parametric Bayesian inference framework may also dynamically adapt its complexity to the observed data, preventing overly complicated models yet catching unexpected patterns in the data as they emerge.

Moreover, the performance of the framework may be evaluated on multiple HV behaviors and/or scenarios. As such, the system may be configured to generate and/or design a set of scenarios, in which F such as straight highway, highway exiting, highway merging, intersection, and/or roundabout scenarios, defined as fₕ, fₑ, fₘ, fᵢ, fᵣ∈F correspondingly. Using these scenarios, AVs may be trained such that the AVs are social-aware by using an altruistic reward that embedded Social Value Orientation (SVO) in the AVs. Properly, social preferences (altruism or egoism) may be described by the AV's SVO angular phase ϕ. To simulate diverse behaviors the appropriate parameter values that simulate the desired behaviors may be computed by the system. In this manner, the HV driver parameters (P) may be computed and/or, based on the parameters (P), generate a set of behaviors B, i.e., conservative, moderate and aggressive, b_{c}, bₘ, bₐ∈B used within the simulator. A mixed behavior scenario may then be obtained by sampling from the behaviors in B.

In addition, the system may focus on prediction-aware planning for altruistic cooperative driving. As such, the scenarios contain a set of AVs iᵢ∈I and HVs hₖ∈H, with diverse SVO. In this manner, the AVs may be connected and perceive a partial observation of the environment õᵢ∈Oᵢ, perceiving a subset of vehicles C=H∪I, i.e., a subset of HVs H⊂H and AVs I⊂I. Accordingly, the following question may be presented: How AVs can leverage prediction in decision-making to learn optimal cooperative policies π*(s) in a mixed-autonomy environment under different HVs behaviors b∈B and scenarios f∈F.

The RL-based altruistic cooperative driving problem is formalized as a POSG as described previously, attempting to obtain optimal policies that produce socially advantageous outcomes. To formalize the prediction problem, the system may represent the state at time t for the vehicle (car) C, C∈C, as s_{tc} ^{and} let sₜ=sₜ^{1, . . . ,|C|} represent the state for all the vehicles within the perception range. The state st may comprise of a stack of N past observations and M future hypotheses accounting for temporal and prediction information, i.e.,

$${s}_{t} = [ {\tilde{o}}_{t - N : t} , {\tilde{o}}_{t + 1 : t + M}^{′} ]$$

for all the vehicles within the local observation. The prediction system takes as input the previous observations õ_{t-N:t} and aims to produce

$${\tilde{o}}_{t + 1 : t + M}^{′} .$$

In this manner, the general notation, and in the framework, st may not be just the vehicle trajectory, but a combination of vehicle kinematic trajectory and a velocity map, the details of which are presented in the following sections.

The previous (õ_{t-N:t}) and anticipated observations

$$( {\tilde{o}}_{t + 1 : t + M}^{′} )$$

are used to learn an optimal policy at a given state sₜ, π*: S→A. The goal is to train prediction-aware and social-aware AVs that can drive safely in a mixed-autonomy scenario.

The POSG becomes significantly more complex in the presence of HVs since their behavior is difficult to predict and change over time. Therefore, predicting HV behavior is crucial for AVs' in a mixed-autonomy environment. On the basis of this insight, the framework may combine prediction and/or planning. Additionally, the predictive network may provide predictions to the planner, and/or the planner may learn to use those predictions for decision-making. The prediction networks give the AV the capability to anticipate the future, such that the VFN may embed the predictions and/or may learn the inter-agent relations while optimizing for a social utility.

Moreover, in an embodiment, the system may use the HPN such that the HPN may provide possible future observations. Then, in this embodiment, the HPN may be used in a multi-step prediction chain that produces multiple possible future observations of the VFN. Finally, the VFN may be trained to optimize a social utility within the RL framework. The VFN may then output Q-values, which may be masked by a safety prioritizer, constraining the RL policy to a safe action space. The outline of the framework of the system may be depicted in FIG. 10.

In addition, the system may comprise at least two main sub-systems. As such, in an embodiment, the at least two main sub-systems may comprise the HPN and/or the VFN, where HPN may be a predictive autoencoder and/or the VFN may be a 3D convolutional neural network (hereinafter “CNN”). As such, in this embodiment, the combination of prediction (hereinafter “HPN”) and/or decision-making (hereinafter “VFN”) may improve the AVs' ability to learn to navigate complex scenarios. The input of the system is the hybrid spatiotemporal state representation, i.e., Velocity Maps and kinematic state and the output are the action-values, and after the unsafe actions are masked, the action with the highest Q-values is selected (α=max_{α′∈A} _{_{safe}}Q(s, a′; w) at the given state s∈S). To encourage the required safe social behavior in the AVs, the system is configured to design a suitable reward function.

As stated above, action-spaces are choses as a collection of discrete meta-actions αᵢ∈Aᵢ at an abstract level, and the abstract actions are transformed into control signals. In this embodiment, the action system comprises as follows:

$${a}_{i} ∈ {A}_{i} = [ \begin{matrix}Lane Left \\ Idle \\ Lane Right \\ Acclerate \\ Decelerate\end{matrix} ] \qquad ( 12 )$$

Addition, as stated above, within a state space, the AVs at every time step t may receive a local observation of the environment õₜ∈Oₜ. As temporal information may be crucial for the driving task the system may incorporate N consecutive observations. Velocity Maps (V M) and Kinematic (K) information may be used, at time step t, each combination of V M and K is an observation from the environment as follows:

$${\tilde{o}}_{t} ∈ {O}_{t} = [ \begin{matrix}{VM}_{t} \\ {k}_{t} = {X}_{t} {Y}_{t} {V}_{t} {Ψ}_{t}\end{matrix} ] \qquad ( 13 )$$

In an embodiment, the kinematic information may also be included to explicitly incorporate the movement data, which helps the training process, and/or may also serve to obtain accurate kinematic prediction for the safety prioritizer. Additionally, in this embodiment, as anticipating futures states may also be important for decision-making in complex scenarios, the prediction chain may be configured to generate a sequence of M hypotheses from the observations that provide information on how the environment could probably evolve into the future. N consecutive past observations and M hypotheses from the prediction network may then be combined by the system to construct a more useful state. Therefore, the state may comprise a stack of N past observations and/or M futures hypothesis, accounting for temporal and prediction information, i.e.,

$${s}_{t} = [ {\tilde{o}}_{t - N : t} , {\tilde{o}}_{t + 1 : t + M}^{′} ] .$$

In addition, in an embodiment, the V M information of the system may incorporate the relative vehicle's speed in pixel values. The Kₜ may be a matrix in which the rows are the number of vehicles included in the observation and the columns contain the kinematics information for each vehicle. The kinematics information for each vehicle c, i.e., kₜ^{c}, is a 4-dimensional vector encoding the vehicle's position, velocity, and/or heading, and/or it may be formed by the kinematics of the vehicle x, y, v, ψ, where (x, y) represents the vehicle position, v is the longitudinal speed, ϕ is the heading, and (x, y) are computed as x=v cos 0, y=v sin ϕ. Furthermore, in this embodiment, the Kₜ may embed the kinematics of surrounding vehicles, and/or it includes the kinematics information kₜ^{c} for all c∈ C vehicles, in addition to the ego vehicle, i.e.,

$${K}_{t} = {[ {k}_{t}^{1} , {k}_{t}^{2} , … {k}_{t}^{[ C ]} ]}^{T} .$$

Each row r of Kₜ matrix contains the kinematics information for the vehicle c,kₜ^{c}=[xₜ^{c}, yₜ^{c}, vₜ^{c}, ψₜ^{c}].

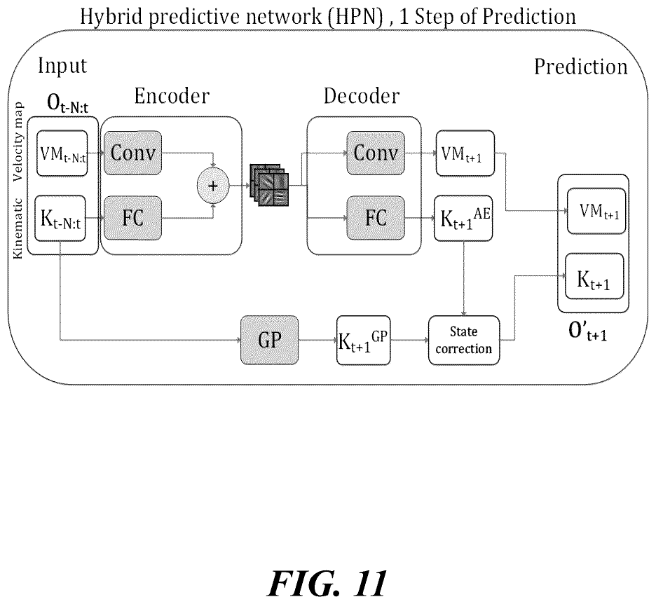

Moreover, in an embodiment, the HPN (as shown in FIG. 11) of the system may serve as a predictive autoencoder network. As such, the HPN may take as input the history of observations at time t, i.e., õ_{t-N:t} and/or may produce a predicted observation at time

$$t + 1 , i . e . , {\tilde{o}}_{t + 1}^{′} .$$

The prediction chain may also be a multi-step prediction chain that uses the HPN in a chain to produce a set of M hypotheses. In this manner the HPN may take a history of observations at time t, i.e., õ_{t-N:t} and/or may synthesize and/or generate a set of M predicted observations, i.e.,

$${\tilde{o}}_{t + 1 : t + M}^{′}$$

for the VFN. Accordingly, in this embodiment, prediction-aware planning may be made possible by combining prediction (HPN) and decision-making (VFN) within the system, which improve driving performance in challenging situations. The details of the architecture may be further detailed within the following disclosure.

In an embodiment, the HPN of the system, as shown in FIG. 11, may be a prediction autoencoder network, it uses the sequence of N observations at time t, i.e., õ_{t-N:t}, via a plurality of vehicle navigation sensors communicatively coupled to a processor of the AV, and outputs a predicted observation at time

$$t + 1 , i . e . , {\tilde{o}}_{t + 1}^{′} .$$

The HPN may comprise a symmetric encoder-decoder architecture. The encoder may comprise at least three (3) convolutional layers with at least one 3×3 filter, with 32, 64, and/or 64 feature maps. The encoder may also take as input the history of observations (õ_{t-N:t}), where each observation may comprise a velocity map image (V Mₜ) and the kinematic matrix (Kₜ). The V M from t−N:t may be passed through the at least 3 convolutional layers and the K vectors from t−N:t may be passed through the at least 2 FC (Fully Connected) layers with 128 hidden units, whose final layer may contain the same number of hidden units as in the Convolution Neural Network (CNN) output. In this embodiment, the outputs (V M features and K features representations) may be combined using element-wise addition operation. The decoder of the system may comprise a symmetric version of the encoder, i.e., a deconvolutional network with at least three (3) convolutional layers and at least two (2) FC layers. The convolutional layers of the system may then produce a prediction for the next VMₜ₊₁′ and/or the FC layers may produce the prediction for the next Kₜ₊₁′. In this manner, the CNN encoder of the system may also be designed to extract important spatial information of the input V M image. The predictive autoencoder may be trained by minimizing the Mean Squared Error (MSE) between the prediction õ′ₜ₊₁ and the target õₜ₊₁

Although the AE provides kinematic predictions, it is found that an indirect hybrid GP prediction approach to correct the kinematic predictions provides better results. The findings are based on previous works that show how a GP-based prediction system is powerful for accurate kinematic predictions and often performs better than other models like AE and LSTM models. Therefore, while the predictive AE is used to predict the next VMₜ′ image and Kₜ′ state, the kinematic state Kₜ′ may be corrected using a GP approach to improve kinematics prediction. Accurate kinematics predictions may be important for the safety prioritizer that uses the predictions to constrain the RL policies to a safer space. Based on the findings, instead of directly using the position time series (x_{t-N:t}, y_{t-N:t}) for each vehicle, the GP inference algorithm treats the vehicles' heading (ψ_{t-N:t}) and speed (v_{t-N:t}) as two independent time series that are regressed using GPs, and then calculates the vehicles' position (x_{t+1:t+M}′, y_{t+1:t+M}′) using the predicted heading and speed. Accordingly, this approach may be called GP-indirect prediction. For each vehicle, c, the GP prediction algorithm takes as input the history of the 4-dimensional vector (x_{t-N:t}, y_{t-N:t}, v_{t-N:t}, ψ_{t-N:t}), uses the heading (ψ_{t-N:t}) and speed (v_{t-N:t}) time series to predict their future values (ψ′_{t+1:t+M}, v′_{t+1:t+M}). Then after modeling speed and heading, the future position of the vehicle, i.e., (x_{t+1:t+M}′, y_{t+1:t+M}′) is computed as follows:

$$\{ {V}_{i} \} i = 1 , 2 , … , m = \{ {f}_{s peed} ( {t}_{i} ) \} i = 1 , 2 , … , m ∼ N ( {μ}_{v} , {\sum }_{v} ) , \qquad ( 14 )$$

$${μ}_{v} = {m}_{v} ( {t}_{i} ) ; {\sum }_{{ν}_{i , j}} = {k}_{v} ( {t}_{i} , {t}_{j} ) ∀ i , j ∈ \{ 1 , 2 , … , m \} , \qquad ( 15 )$$

$${f}_{speed} ( t ) ∼ g p ( {m}_{v} ( t ) , {k}_{v} ( t , {t}^{′} ) ) \qquad ( 16 )$$

$${\{ {ψ}_{i} \}}_{i = 12 , … , m} = {\{ {f}_{heading} ( {t}_{i} ) \}}_{i = 1 , 2 , … , m} ∼ N ( {μ}_{ψ} , {\sum }_{ψ} ) , \qquad ( 17 )$$

$${μ}_{ψ} = {m}_{ψ} ( {t}_{i} ) ; {\sum }_{{ψ}_{i , j}} = {k}_{ψ} ( {t}_{i} , {t}_{j} ) ∀ i , j ∈ \{ 1 , 2 , … , m \} , \qquad ( 18 )$$

$${f}_{heading} ( t ) ∼ g p ( {m}_{ψ} ( t ) , {k}_{ψ} ( t , {t}^{′} ) \qquad ( 19 )$$

$${x}_{t + 1}^{′} = {x}_{t} + {\int }_{t}^{t + 1} {f}_{speed} t cos ( {f}_{heading} ( t ) ) dt \qquad ( 20 )$$

$${y}_{t + 1}^{′} = {y}_{t} + {\int }_{t}^{t + 1} {f}_{speed} t sin ( {f}_{heading} ( t ) ) dt \qquad ( 21 )$$

From the output of the GP model, the 4-dimensional vector (Kₜ₊₁^{GP}=xₜ₊₁, yₜ₊₁, vₜ₊₁, ψₜ₊₁) for each vehicle may be used to correct the AE kinematic prediction (kₜ₊₁^{AE}), and/or the GP prediction may be performed for each vehicle in the K matrix (rows of the matrix) and/or a new matrix may be formed with all the predictions at time t+1, i.e., Kₜ₊₁′=[kₜ₊₁^{ego},kₜ₊₁¹,kₜ₊₁² . . . , kₜ₊₁^{|c|}]. The final predicted observation may be a combination of the predicted velocity map (VMₜ₊₁′) and the corrected kinematic prediction (Kₜ₊₁′), as shown in FIG. 11, i.e.:

$${\tilde{o}}_{t + 1}^{′} = [ \begin{matrix}{VM}_{t + 1}^{′} \\ {k}_{t + 1}^{′} = {X}_{t + 1}^{′} , {Y}_{t + 1}^{′} , {V}_{t + 1}^{′} , {Ψ}_{t + 1}^{′}\end{matrix} ] \qquad ( 22 )$$

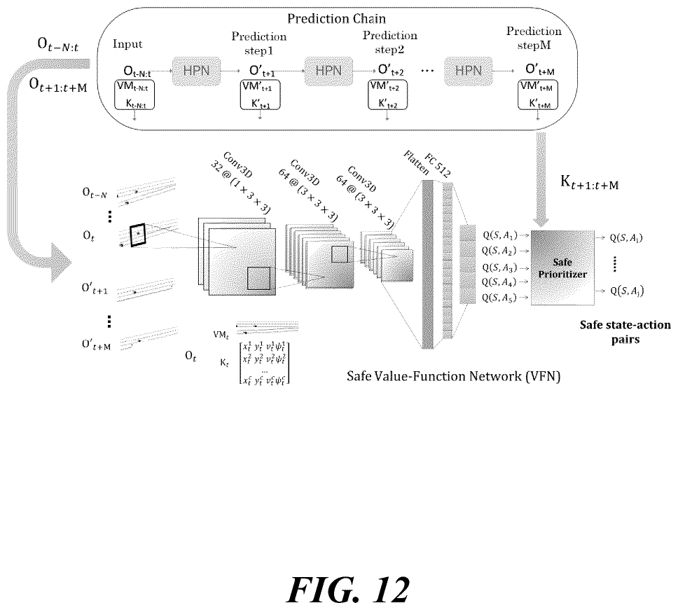

In an embodiment, the prediction chain of the system, as shown in FIG. 12 and Algorithm 1 may comprise a multi-step prediction process that uses the HPN, as shown in FIG. 11, in a chain to produce a set of M future hypotheses. It may take a history of observation at time t, i.e., õ_{t-N:t} and/or may produce a set of M predicted observations,

$$i . e . , {\tilde{o}}_{t + 1 : t + M}^{′} ,$$

as described in Algorithm 1, to compute the input state for the VFN, i.e.,

$${s}_{t} = [ {\tilde{o}}_{t - N : t} , {\tilde{o}}_{t + 1 : t + M}^{′} ] .$$

Algorithm 1:

```
Input õ_{t-N:t}. The sequence of previous observations.
for t = t to t + M do
  $Predict {\tilde{o}}_{t + 1}^{′} = HPN ( {\tilde{o}}_{t N : t} )$
  $Save prediction {\tilde{o}}_{t + 1}^{′} and use it for the next step$
end for
$Output {\tilde{o}}_{t + 1 : t + M}^{′} . The sequence of predicted observations .$
```

In order to improve safety, in an embodiment, the system may comprise a safety prioritizer, the safety prioritizer being proposed within the VFN. The safety prioritizer penalizes high-risk actions, thereby reducing imminent crashes. If the AVs come into an unexpected situation and, based on the output of the VFN, decide to perform a high-risk action, the safety prioritizer may then mask the action. In this embodiment, the safety prioritizer may be comprised of two algorithms, i.e., Algorithm 2 that may be configured to check for safe actions and/or may perform action selection as described previously. Furthermore, Algorithm 2 may verify if the selected action at is safe based on a safety score for Mₛₜₑₚₛ of prediction, i.e.,

$${\tilde{K}}_{t + 1 : t + M}^{′} = HPN ( {\tilde{K}}_{t - N : t} ) ,$$

for all vehicles in the road c∈C to compute the time-to-collision (ttc) at time t, i.e., ttcₜ between Iᵢ and all c∈(I∪H) {Iᵢ} using x, y, v, ψ, at each prediction step is calculated and the minimum ttc is saved, and using the predicted ttc for all the Mₛₜₑₚₛ of prediction (ttc_{t+1:t+M}), the safe_{score} is computed. In this embodiment, the safe_{score} may be a weighted average of the ttc_{t+1:t+M}, with exponential decay to give more importance to the short-term predictions. Finally, if safety_{score}<safeₜₕ or any of the predicted ttc is less than the critical threshold, i.e., any(ttc_{t+1:t+M})<criticalₜₕ, the action is considered unsafe. The safeₜₕ is the safe ttc threshold for a possible crash, and criticalₜₕ is a critical ttc threshold for an imminent crash.

Algorithm 2

```
Simulate Ii taking the action at
Get kinematic predictions from HPN, i.e., \tilde{ }K′
t+1:t+M = HPN (\tilde{ }Kt−N:t) for all vehicles in the road
c ∈ C = (Ĩ∪ \tilde{H})
for t = t + 1 to t + M (Compute safety score for Msteps predictions) do
Compute ttcₜ between Iᵢ and all c ∈ C\{Iᵢ} using x, y, v, φ at time t
Compute min(ttcₜ)
Get next prediction at t = t + 1
end for
Compute safe_{score} using the predicted ttc_{t+1:t+M}
${safe}_{score} = \frac{{\sum }_{i = t + 1}^{t + M} {w}_{i} {ttc}_{t}}{{\sum }_{i = t + 1}^{t + M} {w}_{i}}$
if safe_{score} < safeₑₜₕ or any(ttc_{t+1:t+M}) < ctiricalₜₕ then
    Return unsafe
else
    Return safe
end if
```

Algorithm 3

```
Initialize Ã_{safe} = A
While Ã_{safe} is not empty do
  if during training then
    select aₜfollowing the exploration policy on set Ã_{safe}
  else if during test then
    Select aₜ = max_{a′∈Ã}_{_{safe}} Q(sₜ, a′; w)
  end if
  if aₜ is safe (Algorithm 2) then
    Return aₜ
  else
    Remove aₜ from Ã_{safe}
  end if
end while
Compute the safety_{score} as in Algorithm 2
Return aₜ with the highest safety_{score} in A
```

In an embodiment, the system may be configured to iteratively verifies the actions using Algorithm 3 and/or the system may be configured to select a safe action that follows the learned policy. The restricted actions may prevent the agent from engaging in risky behavior during training, resulting in a more balanced learning and efficient sampling.

The VFN estimates the state-action value function. In an embodiment, the combination of prediction (HPN) and decision-making (VFN) within the system may allow prediction-aware planning and/or may improve the AVs' ability to learn to navigate complex scenarios, and/or the safety prioritizer further increases safety. The proposed approach utilizes Deep Reinforcement Learning (DRL) to achieve a high-level policy for safe tactical decision-making. As presented, in this embodiment, the input may comprise a stack of N past observations and M future hypotheses, i.e., sₜ=[õ_{t-N:t}, õ_{t+1:t+M}, and the 3D CNN operates as a feature extractor. The VFN may be trained to learn the optimal Q-values that maximize the social reward function, optimizing social utility. During training, agents are trained in a semi-sequential manner.

In an embodiment, the VFN may output the Q-values that may be masked by a safety prioritizer, constraining the RL policy to a safe action space. Therefore, in the framework of the system, when the agent policy chooses an unsafe action, the safety prioritizer may mask the action and/or may select a safer action, saving the unsafe action (aₜ) and/or the associated state in the RM with a negative reward (r_{unsafe}). By reducing episode restarts due to potential collisions, the safety prioritizer may increase sample efficiency and/or safety.

The proposed prediction-aware planning and the social-aware optimization algorithm is described in Algorithm 4. In an embodiment, a batch of sample simulations may be run by the system to pre-fill the replay buffer before starting the learning phase. In this embodiment, to account for the unbalance in training data, the experience replay buffer is re-balanced.

Algorithm 4

Define and Initialized Replay Memory buffer RM.
Define and Initialize action-value function \tilde{Q}(.; w⁻) and
Target network \tilde{Q}(.; ŵ) with w⁻ and ŵ = w⁻
Save in the RM the first's Eᵢₙᵢ episodes.
For e = Eᵢₙᵢto N_{episodes} do
Obtain observation history õ_{t-N:t}
Predict M hypothesis õ′_{t+1:t+M} (Algorithm 1)
Compute sₜ = [õ_{t-N:t}, õ′_{t+1:t+M}]
For t = tᵢₙᵢto T do
For Iᵢin I do
For agents Iⱼ, j ≠ i, freeze w⁻
For Nᵢₜₑᵣₐₜᵢₒₙₛ do
With probability ∈ choose aₜ randomly,
Else choose aₜ = max_{a′∈Ã}_{_{safe}} Q(sₜ, a′; w⁺)
Verify Action aₜ (Algorithm 2)
if aₜ is not safe then
Store transition (sₜ, aₜ, r_{unsafe}, Ø) in RM
aₜ = Select a safe action (Algorithm 3)
End if
Take aₜ (a_{safe}), and observe rₜ, õₜ₊₁
Store transition (sₜ, aₜ, rₜ, sₜ₊₁)in RM
Compute wₖ₊₁⁺ ← wₖ⁺ − α\hat{∇}_{w} [symbol] (w⁺)
End for
Disseminate weights w⁻ = w⁺ for all Iᵢ ∈ I
End for
Reset ŵ ← w⁻ every Target_{update}
End For
End for

The previous OpenAI Gym Highway environment was further customized, such that the OpenAI Gym Highway may include prediction within the simulator. Five scenarios for the experiments was developed, i.e., a straight highway, highway exiting, highway merging, intersection, and roundabout scenarios (fₕ, fₑ, fₘ, fᵢ, fᵣ∈F). The AVs are trained surrounded by HVs with various behaviors, i.e., conservative, moderate, and aggressive, (b_{c}, bₘ, bₐ∈B). A scenario with mixed behavior within a mixed-autonomy environment is obtained by sampling from the behaviors in B for each HV. The VFN has trained for N_{episodes}=15,000 episodes and multiple iterations of the training procedure are carried out to guarantee the convergence of the policies. TABLE 3, provided below, lists the training and simulation parameters.

The system's performance is evaluated based on safety, efficiency, and prediction error. Two indicators were selected that, notwithstanding their correlation, offer distinct perspectives on the effectiveness of the approach. The proportion of episodes was then calculated with at least one crash (C (%)) in order to measure safety. The vehicles' average traveled distance (DT (m)) is utilized to measure efficiency. Finally, the prediction error is measured in terms of the Prediction Reconstruction Error (PRE) of the VM predictions and in terms of Position Error (PE) for the kinematic prediction K. Based on those evaluation metrics the following hypotheses were investigated:
H3. The GP is a more powerful approach to predicting time series when compared to the AE for kinematic predictions, therefore, using the GP for kinematic prediction improved the prediction performance when measured by the position error (PE). Additionally, temporal information is important for accurate prediction, a higher performance of the VM prediction is expected from the predictive autoencoder when using the observation history, measured by the prediction reconstruction error (PRE).
H4. The ability to forecast future states improve decision-making in AVs, therefore a performance improvement of the prediction-aware VFN is anticipated, measured in terms of safety and efficiency when using the HPN.

Predicting the actions of HVs is a crucial component of AVs' decision-making. They system may take advantage of this feature and investigate how incorporating prediction into the framework improves safety and efficiency. Particularly, it may be shown that prediction in the image domain allows learning powerful representations, and it may be presented how the HPN learns to predict the V M image and the advantages of using the GP approach to improve kinematic prediction.

H3 is investigated and is shown how using the GP for kinematic prediction improves the prediction performance. Different kinematic prediction baselines are compared and/or the different kinematic prediction baselines may be measured against their performance using the position error (PE) in meters. Five prediction approaches are compared, i.e., the GP prediction approach, an LSTM network, Constant Speed (CS), Constant Acceleration (CA) based prediction, and the predictive AE kinematic prediction. GP, LSTM, and AE can be used to predict time series, and leveraging that, two approaches for each method are considered: direct and indirect prediction. Therefore, eight baselines are compared (e.g., the GP Direct (GP D), the GP Indirect (GP I), LSTM Direct (LSTM D), LSTM Indirect (LSTM I), CS, CA, AE Direct (AE D) and AE Indirect (AE I)).

In a direct prediction approach, (x, y) are regressed by two distinct models learned from the history (x_{t-N:t}, y_{t-N:t}), producing direct predictions of futures (x, y). Differently, in an indirect prediction approach, the vehicle's heading (ϕ_{t-N:t}) and speed (v_{t-N:t}) histories are considered and the models for heading and speed (ϕ, v) are learned using the predictive approach. Using the learned models, the predictions for future heading and speed (ϕ, v) are computed and utilized to calculate future position (x_{t+1:t+M}, y_{t+1:t+M}).

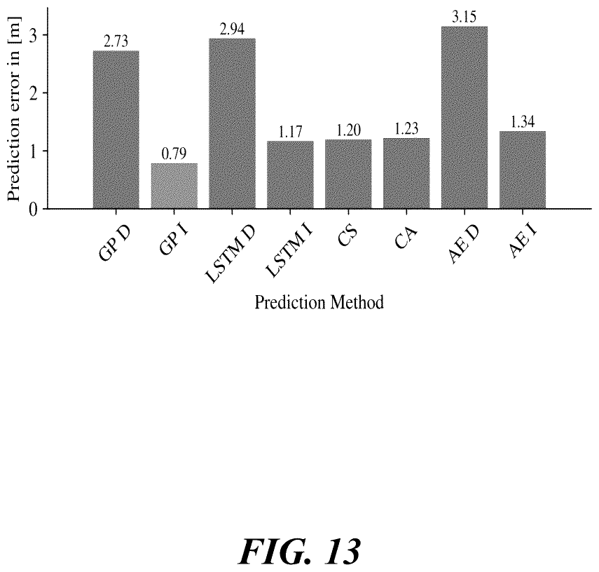

As illustrated in FIG. 13 the indirect GP (GP I, in orange) approach outperforms the other baselines in terms of PE, showing how this non-parametric Bayesian scheme allows the incorporation of complex model structures and is a suitable option for the kinematic prediction method, verifying the H3.

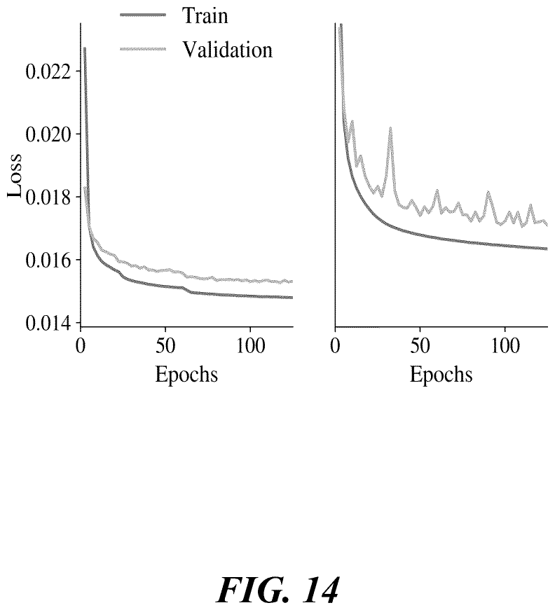

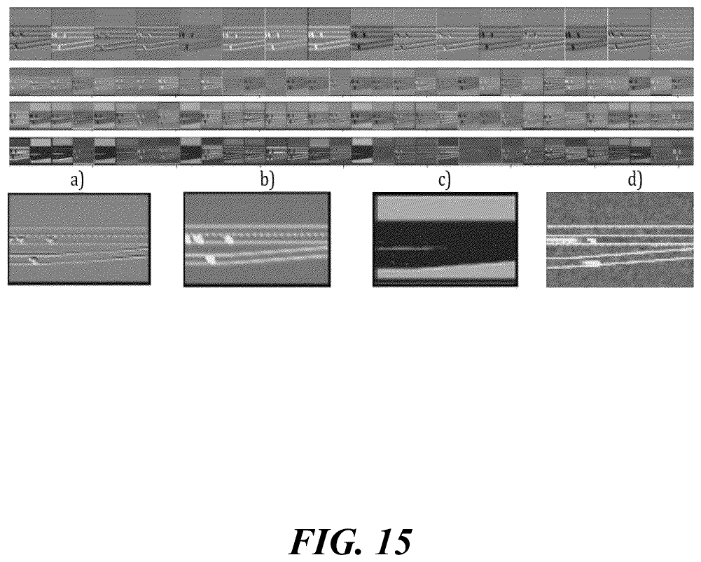

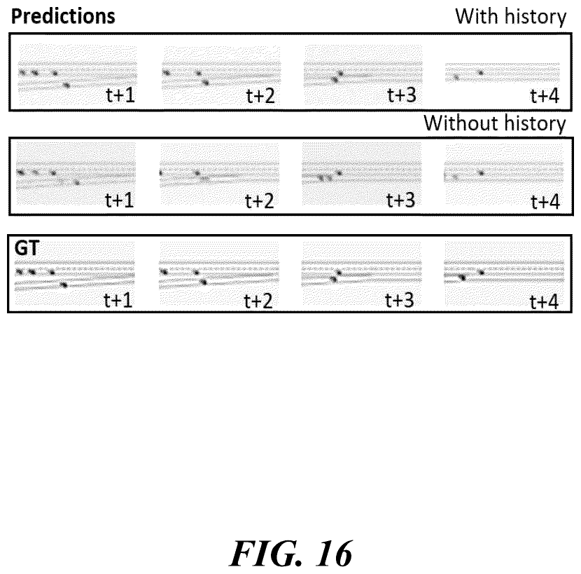

Observation History. Together with the kinematic prediction, the HPN outputs the velocity map image prediction (VM). A prediction reconstruction error (PRE) loss is utilized to calculate the error between the predicted observation õ^{PREα} and the corresponding õ, i.e., [symbol] (õₜ₊₁,õₜ₊₁′)= [symbol] (õₜ₊₁,õₜ₊₁′)². HPN's performance are [symbol] evaluated using only the current observation as input and the history of N observations, demonstrating the importance of temporal information for accurate prediction measured by the PRE. FIG. 14 depicts the training loss results, where the left image is for the HPN that uses the history of N observation and the right image uses just the current observation. As shown in the FIG. 15, when using the temporal information the PRE loss is approximately 20% smaller when using history (left) than without history (right). Similarly, FIG. 16 shows the qualitative output of the HPN prediction chain using the current observation or a history of observations as input. The results with history (top) show clearer and more accurate visual predictions and confirm why the PRE is lower when using the history.

FIG. 15 presents some qualitative results of the internal representations at different layers of the HPN for a merging scenario. In FIG. 15 (bottom), a zoomed-in version of some internal representations are illustrated for visualization. As observed, the HPN learns to extract and highlight important information from the input observation, such as (a) lanes, (b) road agents, (c) road segments, and (d) possible hypotheses on how the environment evolves. Despite the fact that the HPN has not been trained for a segmentation task, it learns to segment the road, agents, and lanes, which could be useful information for the prediction and driving tasks.

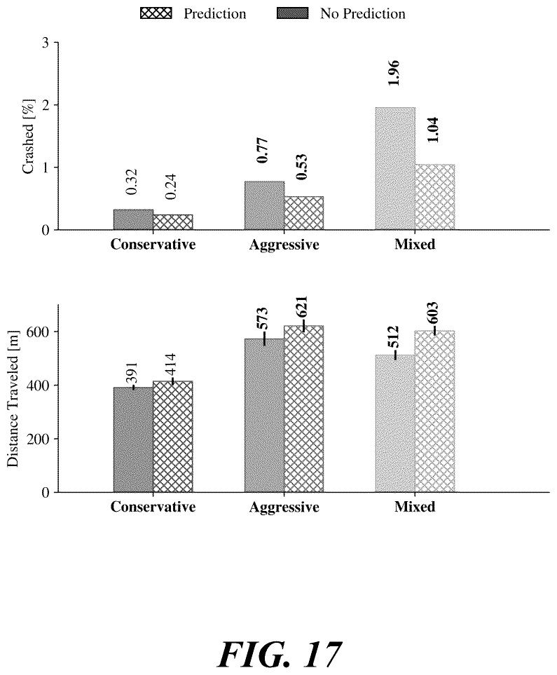

Using the HPN and prediction chain, the VFN is trained to optimize for a social utility. The performance of the VFN is evaluated when using just the history as input, i.e., sₜ=[õ_{t-N:t}] and when additionally utilizing the prediction output of the prediction chain, i.e. sₜ=[õ_{t-N:t}, õ_{t+i:t+M}]. FIG. 17 shows performance improvement by using prediction quantified by crash percentage (Top, C (%)) and average distance traveled (Bottom, DT (m)). The results present the AV's performance in the highway merging scenario fₘ, in the presence of HVs with conservative, aggressive or mixed behavior within the mixed-autonomy environment. It is observed that when train and tests are performed in a conservative environment, or in other words, when HV yields and takes safer actions, the gains from prediction capabilities are not as noticeable, whereas, in an aggressive and mixed scenario within the mixed-autonomy environment in which the behavior changes, the performance increases may be significant. It is believed that anticipating the future may be especially useful in those scenarios, which is why performance has improved.

Furthermore, in an embodiment, the effectiveness of the architecture in diverse scenarios, as well as the performance enhancement of leveraging prediction. It is argued that by using prediction, the VFN may provide a prior on how the world will evolve which is helpful for decision-making. TABLE 3 presents the results in different traffic scenarios, i.e., Exiting (fₑ), Merging (fₘ), Roundabout (fᵣ), intersection (fᵢ), and Highway (fₕ) under mixed HV behaviors (b∈B). The architecture may be compared when using prediction (VFN+P), and/or without prediction (VFN). The architectures as shown in TABLE 4, provided below, outperform the alternative methods, and the improvements are particularly pronounced in the more complex scenarios.

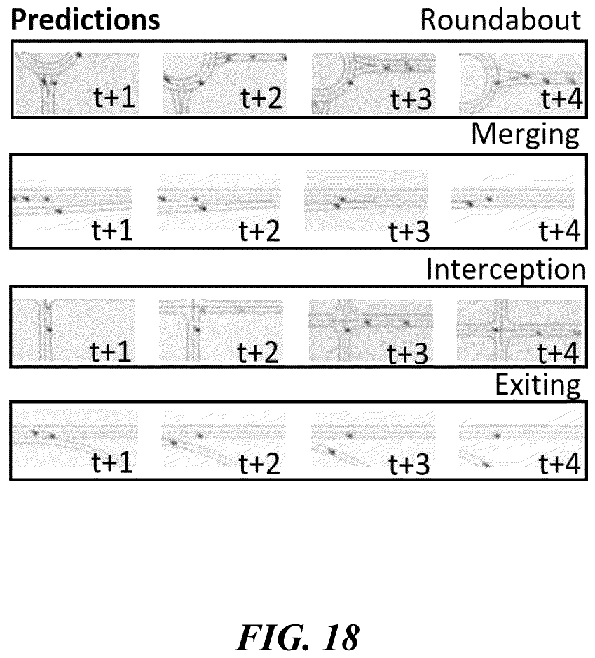

The combination of prediction (HPN) and decision-making (VFN) allows for prediction-aware planning and improves the AVs' ability to learn to navigate complex scenarios, and the safety prioritizer is further improved by leveraging the information provided by the prediction chain, increasing safety and efficiency. The results presented in FIG. 17 and TABLE 4 verify H4. Additionally, FIG. 18 provides the output of the prediction chain for different traffic scenarios, showing qualitative results that further illustrate the capabilities of the prediction network to

The system may be configured to integrate two crucial components for AVs, i.e., social navigation and prediction. The safety and/or reliability of AVs may depend on their predictive capabilities, social awareness, and/or ability to engage in complex social interactions. For that reason, it is proposed that prediction-aware planning and/or social-aware optimization in a cooperative RL framework may allow safe and/or socially-desirable outcomes. As such, the system may provide AVs the ability to anticipate the future, allowing them to take informed decisions and proactive actions in AV-HV social interaction scenarios. The safety prioritizer leverages interpretable kinematic predictions from the HPN to restrict the RL policy to assure safe decision-making, reducing future high-risk actions, increasing awareness of the immediate risks, and consequently decreasing crashes. In this manner, the system may compare the prediction-aware AV to other solutions and demonstrate how the approach consistently improves safety and efficiency on the road in multiple scenarios.

The disclosed reward structure includes a hand-crafted marker that depends on the driving scenario, e.g., merging or exiting a highway. Given diverse driving episodes, this marker can also be learned from interaction data, cutting the need for a mission-specific reward term. It is believed that the merging scenario is representative of many commonly observed interaction scenarios including other behaviors that require the two agents regulating their speeds and coordinating with each other such as exiting a highway. It is hoped to extend the system to other scenarios in the future. It is believed that given a large enough training data, an agent is expected to learn the same altruistic behavior in general driving scenarios.

In this manner, TABLE 4, provided below, depicts a Performance Comparison (Measured by C %) of related architectures showing the performance improvement of the predictive VFN, particularly in challenging scenarios such as intersection and roundabout. The results are shown in different scenarios, Exiting (fₑ), Merging (fₘ), Roundabout (fᵣ), intersection (fᵢ), and Highway (fₕ).

TABLE 3

| Parameter | Value |
|---|---|
| K prediction | GP, RBF kernel |
| Prediction Horizon | 4 s |
| History window | 2 s |
| Latent Dimension | 512 |
| Batch size | 64 |
| Learning rate α₀ | 0.0005 |
| Target_{update} | 300 |
| N_{episode} | 15,000 |
| ϵ decay | Linear |
| RM buffer size | 8,000 |
| Initial exploration ϵ₀ | 1.0 |
| Final exploration | 0.05 |
| Optimizer | ADAM |
| Discount factor γ | 0.95 |

TABLE 4

| Approach | fₑ | fₘ | fᵣ | fᵢ | fₕ |
|---|---|---|---|---|---|
| Conv2D + DQN [94] | 24.62 | 29.12 | 49.03 | 54.78 | 17.21 |
| Conv3D + A2C [44] | 9.23 | 14.99 | 21.17 | 36.62 | 7.43 |
| Conv3D + DQN [45] | 3.91 | 2.59 | 14.62 | 24.30 | 1.31 |
| Safe DQN [91] | 2.51 | 1.95 | 9.04 | 18.67 | 0.44 |
| VFN | 2.47 | 1.96 | 8.94 | 17.90 | 0.39 |
| VFN + P | 1.91 | 1.04 | 7.01 | 11.10 | 0.31 |

As stated above, the present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

### INCORPORATION BY REFERENCE

P. Palanisamy, “Multi-agent connected autonomous driving using deep reinforcement learning,” in 2020 International Joint Conference on Neural Networks (IJCNN). IEEE, 2020, pp. 1-7.
B. Toghi, M. Saifuddin, H. N. Mahjoub, M. Mughal, Y. P. Fallah, J. Rao, and S. Das, “Multiple access in cellular v2x: Performance analysis in highly congested vehicular networks,” in 2018 IEEE Vehicular Networking Conference (VNC). IEEE, 2018, pp. 1-8.
B. Toghi, M. Saifuddin, Y. P. Fallah, and M. Mughal, “Analysis of distributed congestion control in cellular vehicle-to-everything networks,” in 2019 IEEE 90th Vehicular Technology Conference (VTC2019-Fall). IEEE, 2019, pp. 1-7.
W. Schwarting, A. Pierson, J. Alonso-Mora, S. Karaman, and D. Rus, “Social behavior for autonomous vehicles,” Proceedings of the National Academy of Sciences, vol. 116, no. 50, pp. 24 972-24 978, 2019.
A. Alahi, K. Goel, V. Ramanathan, A. Robicquet, L. Fei-Fei, and S. Savarese, “Social lstm: Human trajectory prediction in crowded spaces,” in Proceedings of the IEEE conference on computer vision and pattern recognition, 2016, pp. 961-971.
D. Sadigh, S. Sastry, S. A. Seshia, and A. D. Dragan, “Planning for autonomous cars that leverage effects on human actions.” in Robotics: Science and Systems, vol. 2. Ann Arbor, MI, USA, 2016.
J. Guanetti, Y. Kim, and F. Borrelli, “Control of connected and automated vehicles: State of the art and future challenges,” Annual reviews in control, vol. 45, pp. 18-40, 2018.
J. N. Foerster, R. Y. Chen, M. Al-Shedivat, S. Whiteson, P. Abbeel, and I. Mordatch, “Learning with opponent-learning awareness,” arXiv preprint arXiv:1709.04326, 2017.
J. Foerster, N. Nardelli, G. Farquhar, T. Afouras, P. H. Torr, P. Kohli, and S. Whiteson, “Stabilizing experience replay for deep multi-agent reinforcement learning,” in International conference on machine learning. PMLR, 2017, pp. 1146-1155.
A. Xie, D. Losey, R. Tolsma, C. Finn, and D. Sadigh, “Learning latent representations to influence multi-agent interaction,” in Proceedings of the 4th Conference on Robot Learning (CoRL), November 2020.
J. Foerster, G. Farquhar, T. Afouras, N. Nardelli, and S. Whiteson, “Counterfactual multi-agent policy gradients,” in Proceedings of the AAAI Conference on Artificial Intelligence, vol. 32, no. 1, 2018.
M. Egorov, “Multi-agent deep reinforcement learning,” CS231n: convolutional neural networks for visual recognition, pp. 1-8, 2016.
S. Omidshafiei, J. Pazis, C. Amato, J. P. How, and J. Vian, “Deep decentralized multi-task multi-agent reinforcement learning under partial observability,” in International Conference on Machine Learning. PMLR, 2017, pp. 2681-2690.
H. N. Mahjoub, B. Toghi, and Y. P. Fallah, “A driver behavior modeling structure based on non-parametric Bayesian stochastic hybrid architecture,” in 2018 IEEE 88th Vehicular Technology Conference (VTC-Fall), 2018, pp. 1-5.
“A stochastic hybrid framework for driver behavior modeling based on hierarchical Dirichlet process,” in 2018 IEEE 88th Vehicular Technology Conference (VTC-Fall), 2018, pp. 1-5.
G. Shah, R. Valiente, N. Gupta, S. O. Gani, B. Toghi, Y. P. Fallah, and S. D. Gupta, “Real-time hardware-in-the-loop emulation framework for dsrc-based connected vehicle applications,” in 2019 IEEE 2nd Connected and Automated Vehicles Symposium (CAVS). IEEE, 2019, pp. 1-6.
B. Toghi, D. Grover, M. Razzaghpour, R. Jain, R. Valiente, M. Zaman, G. Shah, and Y. P. Fallah, “A maneuver-based urban driving dataset and model for cooperative vehicle applications,” 2020.
C. Wu, A. M. Bayen, and A. Mehta, “Stabilizing traffic with autonomous vehicles,” in 2018 IEEE International Conference on Robotics and Automation (ICRA). IEEE, 2018, pp. 6012-6018.
D. A. Lazar, E. Biyik, D. Sadigh, and R. Pedarsani, “Learning how to dynamically route autonomous vehicles on shared roads,” arXiv preprint arXiv:1909.03664, 2019.
A. Pokle, R. Martín-Martín, P. Goebel, V. Chow, H. M. Ewald, J. Yang, Z. Wang, A. Sadeghian, D. Sadigh, S. Savarese et al., “Deep local trajectory replanning and control for robot navigation,” in 2019 International Conference on Robotics and Automation (ICRA). IEEE, 2019, pp. 5815-5822.
Y. F. Chen, M. Everett, M. Liu, and J. P. How, “Socially aware motion planning with deep reinforcement learning,” in 2017 IEEE/RSJ International Conference on Intelligent Robots and Systems (IROS). IEEE, 2017, pp. 1343-1350.
M. Tan, “Multi-agent reinforcement learning: Independent vs. cooperative agents,” in Proceedings of the tenth international conference on machine learning, 1993, pp. 330-337.
V. Mnih, K. Kavukcuoglu, D. Silver, A. Graves, I. Antonoglou, D. Wierstra, and M. Riedmiller, “Playing Atari with deep reinforcement learning,” arXiv preprint arXiv:1312.5602, 2013.
B. Toghi, R. Valiente, D. Sadigh, R. Pedarsani, and Y. P. Fallah, “Social coordination and altruism in autonomous driving,” 2021.
T. Schaul, J. Quan, I. Antonoglou, and D. Silver, “Prioritized experience replay,” arXiv preprint arXiv:1511.05952, 2015.
E. Leurent, Y. Blanco, D. Efimov, and O.-A. Maillard, “Approximate robust control of uncertain dynamical systems,” arXiv preprint arXiv:1903.00220, 2019.
M. Treiber, A. Hennecke, and D. Helbing, “Congested traffic states in empirical observations and microscopic simulations,” Physical review E, vol. 62, no. 2, p. 1805, 2000.
A. Kesting, M. Treiber, and D. Helbing, “General lane-changing model mobil for car-following models,” Transportation Research Record, vol. 1999, no. 1, pp. 86-94, 2007.
A. Cosgun, L. Ma, J. Chiu, J. Huang, M. Demir, A. M. Anon, T. Lian, H. Tafish, and S. Al-Stouhi, “Towards full automated drive in urban environments: A demonstration in Gomentum station, California,” in 2017 IEEE Intelligent Vehicles Symposium (IV). IEEE, 2017, pp. 1811-1818.
W. Schwarting, A. Pierson, J. Alonso-Mora, S. Karaman, and D. Rus, “Social behavior for autonomous vehicles,” Proceedings of the National Academy of Sciences, vol. 116, no. 50, pp. 24 972-24 978, 2019.
F. Sagberg, Selpi, G. F. Bianchi Piccinini, and J. Engstrom, “A review of research on driving styles and road safety,” Human factors, vol. 57, no. 7, pp. 1248-1275, 2015.
S. Mozaffari, O. Y. Al-Jarrah, M. Dianati, P. Jennings, and A. Mouzakitis, “Deep learning-based vehicle behavior prediction for autonomous driving applications: A review,” IEEE Transactions on Intelligent Transportation Systems, vol. 23, no. 1, pp. 33-47, 2020.
S. Aoki, T. Higuchi, and O. Altintas, “Cooperative perception with deep reinforcement learning for connected vehicles,” in 2020 IEEE Intelligent Vehicles Symposium (IV). IEEE, 2020, pp. 328-334.
B. Toghi, M. Saifuddin, M. Mughal, and Y. P. Fallah, “Spatiotemporal dynamics of cellular v2x communication in dense vehicular networks,” in 2019 IEEE 2nd Connected and Automated Vehicles Symposium (CAVS). IEEE, 2019, pp. 1-5.
G. Shah, R. Valiente, N. Gupta, S. O. Gani, B. Toghi, Y. P. Fallah, and S. D. Gupta, “Real-time hardware-in-the-loop emulation framework for dsrc-based connected vehicle applications,” in 2019 IEEE 2nd Connected and Automated Vehicles Symposium (CAVS). IEEE, 2019, pp. 1-6.
G. Shah, M. Saifuddin, Y. P. Fallah, and S. D. Gupta, “Rve-cv2x: A scalable emulation framework for real-time evaluation of cv2x-based connected vehicle applications,” in 2020 IEEE Vehicular Networking Conference (VNC). IEEE, 2020, pp. 1-8.
G. Shah, S. Shahram, Y. Fallah, D. Tian, and E. Moradi-Pari, “Enabling a cooperative driver messenger system for lane change assistance application,” arXiv preprint arXiv:2207.12574, 2022.
B. Ivanovic and M. Pavone, “The trajectron: Probabilistic multi-agent trajectory modeling with dynamic spatiotemporal graphs,” in Proceedings of the IEEE/CVF International Conference on Computer Vision, 2019, pp. 2375-2384.
“Injecting planning-awareness into prediction and detection evaluation,” in 2022 IEEE Intelligent Vehicles Symposium (IV). IEEE, 2022, pp. 821-828.
A. Xie, D. Losey, R. Tolsma, C. Finn, and D. Sadigh, “Learning latent representations to influence multi-agent interaction,” in Proceedings of the 4th Conference on Robot Learning (CoRL), November 2020.
H. N. Mahjoub, A. Raftari, R. Valiente, Y. P. Fallah, and S. K. Mahmud, “Representing realistic human driver behaviors using a finite size gaussian process kernel bank,” in 2019 IEEE Vehicular Networking Conference (VNC). IEEE, 2019, pp. 1-8.
J. Rios-Torres and A. A. Malikopoulos, “A survey on the coordination of connected and automated vehicles at intersections and merging at highway on-ramps,” IEEE Transactions on Intelligent Transportation Systems, vol. 18, no. 5, pp. 1066-1077, 2016.
Y. Lin, J. McPhee, and N. L. Azad, “Anti-jerk on-ramp merging using deep reinforcement learning,” in 2020 IEEE Intelligent Vehicles Symposium (IV). IEEE, 2020, pp. 7-14.
B. Toghi, R. Valiente, D. Sadigh, R. Pedarsani, and Y. P. Fallah, “Altruistic maneuver planning for cooperative autonomous vehicles using multi-agent advantage actor-critic,” in Proceedings of the IEEE/CVF Conference on Computer Vision and Pattern Recognition (CVPR) Workshops, 2021.
B. Toghi, R. Valiente, D. Sadigh, R. Pedarsani, and Y. P. Fallah, “Cooperative autonomous vehicles that sympathize with human drivers,” in 2021 IEEE/RSJ International Conference on Intelligent Robots and Systems (IROS), IEEE, 2021.
A. Pokle, R. Martín-Martín, P. Goebel, V. Chow, H. M. Ewald, J. Yang, Z. Wang, A. Sadeghian, D. Sadigh, S. Savarese et al., “Deep local trajectory replanning and control for robot navigation,” in 2019 International Conference on Robotics and Automation (ICRA). IEEE, 2019, pp. 5815-5822.
B. Ivanovic, E. Schmerling, K. Leung, and M. Pavone, “Generative modeling of multimodal multi-human behavior. in 2018 i.e.,” in RSJ International Conference on Intelligent Robots and Systems, 2018, pp. 3088-3095.
M. Kuderer, S. Gulati, and W. Burgard, “Learning driving styles for autonomous vehicles from demonstration,” in 2015 IEEE International Conference on Robotics and Automation (ICRA). IEEE, 2015, pp. 2641-2646.
D. Sadigh, N. Landolfi, S. S. Sastry, S. A. Seshia, and A. D. Dragan, “Planning for cars that coordinate with people: leveraging effects on human actions for planning and active information gathering over human internal state,” Autonomous Robots, vol. 42, no. 7, pp. 1405-1426, 2018.
D. Hadfield-Menell, S. J. Russell, P. Abbeel, and A. Dragan, “Cooperative inverse reinforcement learning,” Advances in neural information processing systems, vol. 29, pp. 3909-3917, 2016.
P. Trautman and A. Krause, “Unfreezing the robot: Navigation in dense, interacting crowds,” in 2010 IEEE/RSJ International Conference on Intelligent Robots and Systems. IEEE, 2010, pp. 797-803.
S. Nikolaidis, R. Ramakrishnan, K. Gu, and J. Shah, “Efficient model learning from joint-action demonstrations for human-robot collaborative tasks,” in 2015 10th ACM/IEEE International Conference on Human-Robot Interaction (HRI). IEEE, 2015, pp. 189-196.
D. Sadigh, S. Sastry, S. A. Seshia, and A. D. Dragan, “Planning for autonomous cars that leverage effects on human actions.” in Robotics: Science and Systems, vol. 2. Ann Arbor, MI, USA, 2016.
Wu, A. M. Bayen, and A. Mehta, “Stabilizing traffic with autonomous vehicles,” in 2018 IEEE International Conference on Robotics and Automation (ICRA). IEEE, 2018, pp. 6012-6018.
D. A. Lazar, E. Biyik, D. Sadigh, and R. Pedarsani, “Learning how to dynamically route autonomous vehicles on shared roads,” arXiv preprint arXiv:1909.03664, 2019.
E. Biyik, D. A. Lazar, R. Pedarsani, and D. Sadigh, “Incentivizing efficient equilibria in traffic networks with mixed autonomy,” IEEE Transactions on Control of Network Systems, vol. 8, no. 4, pp. 1717-1729, 2021.
S. Li, Z. Yan, and C. Wu, “Learning to delegate for large-scale vehicle routing,” Advances in Neural Information Processing Systems, vol. 34, 2021.
K. Srinivasan, B. Eysenbach, S. Ha, J. Tan, and C. Finn, “Learning to be safe: Deep rl with a safety critic,” 2020. [Online]. Available: https://arxiv.org/abs/2010.14603
M. Razzaghpour, S. Mosharafian, A. Raftari, J. Mohammadpour Velni, and Y. P. Fallah, “Impact of information flow topology on safety of tightly-coupled connected and automated vehicle platoons utilizing stochastic control,” in (ECC 2022).
Z. Li, U. Kalabi'c, and T. Chu, “Safe reinforcement learning: Learning with supervision using a constraint-admissible set,” in 2018 Annual American Control Conference (ACC). IEEE, 2018, pp. 6390-6395.
J. Wang, Q. Zhang, D. Zhao, and Y. Chen, “Lane change decision-making through deep reinforcement learning with rule-based constraints,” in 2019 International Joint Conference on Neural Networks (IJCNN). IEEE, 2019, pp. 1-6.
C. Hickert, S. Li, and C. Wu, “Cooperation for scalable supervision of autonomy in mixed traffic,” arXiv e-prints, pp. arXiv-2112, 2021.
S. Nageshrao, H. E. Tseng, and D. Filev, “Autonomous highway driving using deep reinforcement learning,” in 2019 IEEE International Conference on Systems, Man and Cybernetics (SMC). IEEE, 2019, pp. 2326-2331.
A. Mohammadhasani, H. Mehrivash, A. Lynch, and Z. Shu, “Reinforcement learning based safe decision making for highway autonomous driving,” arXiv preprint arXiv:2105.06517, 2021.
D. Chen, Z. Li, Y. Wang, L. Jiang, and Y. Wang, “Deep multi-agent reinforcement learning for highway on-ramp merging in mixed traffic,” arXiv preprint arXiv:2105.05701, 2021.
K. Brown, K. Driggs-Campbell, and M. J. Kochenderfer, “A taxonomy and review of algorithms for modeling and predicting human driver behavior. arxiv e-prints, article,” arXiv preprint arXiv:2006.08832, 2020.
A. Jami, M. Razzaghpour, H. Alnuweiri, and Y. P. Fallah, “Augmented driver behavior models for high-fidelity simulation study of crash detection algorithms,” 2022. [Online]. Available: https://arxiv.org/abs/2208.05540.
M. Lauer and M. Riedmiller, “An algorithm for distributed reinforcement learning in cooperative multi-agent systems,” in In Proceedings of the Seventeenth International Conference on Machine Learning. Citeseer, 2000.
S. Omidshafiei, J. Pazis, C. Amato, J. P. How, and J. Vian, “Deep decentralized multi-task multi-agent reinforcement learning under partial observability,” in International Conference on Machine Learning. PMLR, 2017, pp. 2681-2690.
Z. Constantinescu, C. Marinoiu, and M. Vladoiu, “Driving style analysis using data mining techniques,” International Journal of Computers Communications & Control, vol. 5, no. 5, pp. 654-663, 2010.
K. H. Beck, B. Ali, and S. B. Daughters, “Distress tolerance as a predictor of risky and aggressive driving,” Traffic injury prevention, vol. 15, no. 4, pp. 349-354, 2014.
R. Chandra, U. Bhattacharya, T. Mittal, A. Bera, and D. Manocha, “Cmetric: A driving behavior measure using centrality functions,” in 2020 IEEE/RSJ International Conference on Intelligent Robots and Systems (IROS). IEEE, 2020, pp. 2035-2042.
D. Helbing and P. Molnar, “Social force model for pedestrian dynamics,” Physical review E, vol. 51, no. 5, p. 4282, 1995.
R. Parker and S. Valaee, “Cooperative vehicle position estimation,” in IEEE International Conference on Communications, 2007.
S. Baek, C. Liu, P. Watta, and Y. L. Murphey, “Accurate vehicle position estimation using a Kalman filter and neural network-based approach,” in 2017 IEEE Symposium Series on Computational Intelligence (SSCI). IEEE, 2017, pp. 1-8.
J. H. Painter, D. Kerstetter, and S. Jowers, “Reconciling steady-state Kalman and alpha-beta filter design,” 1990.
L. Chu, Y. Shi, Y. Zhang, H. Liu, and M. Xu, “Vehicle lateral and longitudinal velocity estimation based on adaptive kalman filter,” in ICACTE 2010-2010 3rd International Conference on Advanced Computer Theory and Engineering, Proceedings, 2010.
H. N. Mahjoub, B. Toghi, S. M. O. Gani, and Y. P. Fallah, “V2X system architecture utilizing hybrid gaussian process-based model structures,” in 2019 IEEE International Systems Conference (SysCon), April 2019, pp. 1-7.
N. Lee and K. M. Kitani, “Predicting wide receiver trajectories in American football,” in 2016 IEEE Winter Conference on Applications of Computer Vision (WACV). IEEE, 2016, pp. 1-9.
J. Morton, T. A. Wheeler, and M. J. Kochenderfer, “Analysis of recurrent neural networks for probabilistic modeling of driver behavior,” IEEE Transactions on Intelligent Transportation Systems, vol. 18, no. 5, pp. 1289-1298, 2016.
A. Alahi, V. Ramanathan, K. Goel, A. Robicquet, A. A. Sadeghian, L. Fei-Fei, and S. Savarese, “Learning to predict human behavior in crowded scenes,” in Group and Crowd Behavior for Computer Vision. Elsevier, 2017, pp. 183-207.
Y. Wang, Z. Wang, K. Han, P. Tiwari, and D. B. Work, “Gaussian process-based personalized adaptive cruise control,” IEEE Transactions on Intelligent Transportation Systems, pp. 1-12, 2022.
S. Mosharafian, M. Razzaghpour, Y. P. Fallah, and J. M. Velni, “Gaussian process based stochastic model predictive control for cooperative adaptive cruise control,” in 2021 IEEE Vehicular Networking Conference (VNC), 2021, pp. 17-23.
K. Das and A. N. Srivastava, “Block-GP: Scalable gaussian process regression for multimodal data,” in 2010 IEEE International Conference on Data Mining. IEEE, 2010, pp. 791-796.
J. M. Wang, D. J. Fleet, and A. Hertzmann, “Gaussian process dynamical models for human motion,” IEEE transactions on pattern analysis and machine intelligence, vol. 30, no. 2, pp. 283-298, 2007.
D. Guan, H. Zhao, L. Zhao, and K. Zheng, “Intelligent prediction of mobile vehicle trajectory based on space-time information,” in 2019 IEEE 89th Vehicular Technology Conference (VTC2019-Spring). IEEE, 2019, pp. 1-5.
I. Goodfellow, J. Pouget-Abadie, M. Mirza, B. Xu, D. Warde-Farley, S. Ozair, A. Courville, and Y. Bengio, “Generative adversarial nets,” Advances in neural information processing systems, vol. 27, 2014.
K. Sohn, H. Lee, and X. Yan, “Learning structured output representation using deep conditional generative models,” Advances in neural information processing systems, vol. 28, 2015.
C. E. Rasmussen and C. K. I. Williams, Gaussian Processes for Machine Learning. The MIT Press, 2006.
B. Toghi, R. Valiente, D. Sadigh, R. Pedarsani, and Y. P. Fallah, “Social coordination and altruism in autonomous driving,” arXiv preprint arXiv:2107.00200, 2021.
R. Valiente, B. Toghi, R. Pedarsani, and Y. P. Fallah, “Robustness and adaptability of reinforcement learning-based cooperative autonomous driving in mixed-autonomy traffic,” IEEE Open Journal of Intelligent Transportation Systems, vol. 3, pp. 397-410, 2022.
E. Leurent, Y. Blanco, D. Efimov, and O.-A. Maillard, “Approximate robust control of uncertain dynamical systems,” arXiv preprint arXiv:1903.00220, 2019.
M. Treiber, A. Hennecke, and D. Helbing, “Congested traffic states in empirical observations and microscopic simulations,” Physical review E, vol. 62, no. 2, p. 1805, 2000.
H. Van Hasselt, A. Guez, and D. Silver, “Deep reinforcement learning with double q-learning,” in Proceedings of the AAAI conference on artificial intelligence, vol. 30, no. 1, 2016.
Valiente Romero, Rodolfo & Razzaghpour, Mahdi & Toghi, Behrad & Shah, Ghayoor & Fallah, Yaser. (2022). Prediction-aware and Reinforcement Learning based Altruistic Cooperative Driving. 10.48550/arXiv.2211.10585.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A method for automatic autonomous vehicle navigation, the method comprising:
importing, via a plurality of vehicle navigation sensors communicatively coupled to a processor, a plurality of observations of a mixed-autonomy environment at a predetermined time t into a Hybrid Predictive Network (HPN);
synthesizing, via the HPN, a plurality of future hypotheses of the mixed-autonomy environment during at least one alternative time, t+1, based on the imported observations;
estimating, via a Value Function Network (VFN) communicatively coupled to the HPN, state-action value functions based on the plurality of synthesized future hypothesis; and
penalizing, via a safety prioritizer of the VFN, at least one estimated high-risk state-action, and masking the at least one estimated high-risk state-action when the at least one high-risk state-action is selected.

2. The method of claim 1, wherein the step of synthesizing a plurality of future hypotheses further comprises the step of, generating, via the HPN, a multi-step prediction chain to transmit at least one of the plurality of future hypotheses to the VFN.

3. The method of claim 1, further comprising the step of, generating, via a deep Reinforcement Learning (RL) module communicatively coupled to the VFN, a high-level policy for safe tactical decision-making with the input comprising a stack of the plurality of observations and a stack of the plurality of future hypotheses.

4. The method of claim 3, wherein the step of generating a high-level policy for safe tactile decision-making further comprises the step of, training, via the deep RL module, a plurality of agents of the VFN, whereby the estimated state-action value functions optimize a Q-value that maximizes a social reward function.

5. The method of claim 4, wherein the plurality of agents of the VFN are trained in a semi-sequential manner.

6. The method of claim 1, wherein the HPN employs a symmetric encoder-decoder architecture.

7. The method of claim 6, wherein the encoder comprises at least three (3) convolutional layers and at least one fully connected layer.

8. The method of claim 7, wherein the step of synthesizing, via the HPN, a plurality of future hypotheses of the mixed-autonomy environment further comprises the step of, encoding, via the encoder, each of the plurality of observations to generate a plurality of hidden units.

9. The method of claim 8, wherein the decoder comprises at least three (3) convolution layers with at least one fully connected layer.

10. The method of claim 9, wherein the step of synthesizing, via the HPN, a plurality of future hypotheses of the mixed-autonomy environment further comprises the step of, subsequent to encoding each of the plurality of observations, decoding, via the decoder, each of the plurality of generated hidden units to product at least one future hypothesis for at least one portion of the mixed-autonomy environment.

11. The method of claim 10, further comprising the step of, extracting, via the encoder, spatial information from the plurality of observations, whereby the spatial information is transmitted to the deep RL module, thereby optimizing training of the encoder-decoder architecture.

12. A system for automatic autonomous vehicle navigation, the system comprising:
a computing device having a processor; and
a non-transitory computer-readable medium operably coupled to the processor, the computer-readable medium having computer-readable instructions stored thereon that, when executed by the processor, cause the system to automatically navigate an autonomous vehicle within a mixed-autonomy environment by executing instructions comprising:
importing, via a plurality of vehicle navigation sensors communicatively coupled to the processor, a plurality of observations of a mixed-autonomy environment at a predetermined time t into a Hybrid Predictive Network (HPN);
synthesizing, via the HPN, a plurality of future hypotheses of the mixed-autonomy environment during at least one alternative time, t+1, based on the imported observations;
estimating, via a Value Function Network (VFN) communicatively coupled to the HPN, state-action value functions based on the plurality of synthesized future hypothesis; and
penalizing, via a safety prioritizer of the VFN, at least one estimated high-risk state-action, and masking the at least one estimated high-risk state-action when the at least one high-risk state-action is selected.

13. The system of claim 12, wherein the step of synthesizing a plurality of future hypotheses of the executed instructions further comprises the step of, generating, via the HPN, a multi-step prediction chain to transmit at least one of the plurality of future hypotheses to the VFN.

14. The method of claim 12, wherein the executed instructions further comprise the step of, generating, via a deep Reinforcement Learning (RL) module communicatively coupled to the VFN, a high-level policy for safe tactical decision-making with the input comprising a stack of the plurality of observations and a stack of the plurality of future hypotheses.

15. The system of claim 14, wherein the step of generating a high-level policy for safe tactile decision-making of the executed instructions further comprises the step of, training, via the deep RL module, a plurality of agents of the VFN, whereby the estimated state-action value functions optimize a Q-value that maximizes a social reward function.

16. The system of claim 15, wherein the plurality of agents of the VFN are trained in a semi-sequential manner.

17. The system of claim 12, wherein the HPN employing a symmetric encoder-decoder architecture.

18. The system of claim 17, wherein the encoder comprises at least three (3) convolutional layers and at least one fully connected layer.

19. The system of claim 18, wherein the step of synthesizing, via the HPN, a plurality of future hypotheses of the mixed-autonomy environment of the executed instructions further comprises the step of, encoding, via the encoder, each of the plurality of observations to generate a plurality of hidden units.

20. The system of claim 19, wherein the decoder comprises at least three (3) convolution layers with at least one fully connected layer.
